(19) United States
(12) Patent Application Publication
(10) Pub. No.: US 2026/0243610 A1
(43) Pub. Date: Aug. 20, 2026

(54) ACTIVATABLE ENVIRONMENTAL EXPOSURE INDICATOR WITH TAILORABLE RESPONSE CONDITIONS

(71) Applicant: Zebra Technologies Corporation, Lincolnshire, IL (US)

(72) Inventors: Eric W. Liberato, Pequannock, NJ (US); Sean MacDavitt, Locust Valley, NY (US); Brian S. Huffman, Belle Mead, NJ (US); Mohannad Abdo, Clifton, NJ (US)

(73) Assignee: Zebra Technologies Corporation, Lincolnshire, IL (US)

(21) Appl. No.: 19/055,909

(22) Filed: Feb. 18, 2025

(51) Int. Cl. G01K 11/12; G01K 3/00; G01N 31/22

(52) U.S. Cl. CPC G01K 11/12; G01K 3/00; G01N 31/229

(57) ABSTRACT

Activatable environmental exposure indicators with tailorable response conditions are described herein. An activatable environmental exposure indicator with tailorable response conditions may be provided by an activatable environmental exposure indicator including a substrate, an indicator region defined on, or operatively coupled to the substrate, an activation region in fluid communication with the indicator region, a plurality of first type microcapsules disposed in the activation region, each first type microcapsule of the plurality of first type microcapsules including a first type payload microencapsulated in a first type frangible shell, and a plurality of second type microcapsules disposed in the activation region, each second type microcapsule of the plurality of second type microcapsules including a second type payload microencapsulated in a second type frangible shell.

### BACKGROUND

Environmental indicators may be configured to indicate the occurrence of an environmental exposure to a host product. Prior to the association between the host product and the indicator, the same level of care must often be paid to the indicator to prevent an exposure to the environmental condition which the indicator is configured to indicate, so that the indicator is not triggered prematurely and rendered unusable for use with the host product. For example, high temperature exposure indicators may need to be kept in deep freeze or refrigerated conditions, complicating the component supply chains for the products they are used with. Activatable environmental indicators have been previously proposed.

### SUMMARY

In an example embodiment, the present disclosure describes an activatable environmental exposure indicator, including a substrate, an indictor region defined on, or operatively coupled to the substrate, an activation region in fluid communication with the indicator region, a plurality of first type microcapsules disposed in the activation region, each first type microcapsule of the plurality of first type microcapsules including a first type payload microencapsulated in a first type frangible shell, and a plurality of second type microcapsules disposed in the activation region, each second type microcapsule of the plurality of second type microcapsules including a second type payload microencapsulated in a second type frangible shell. The first type frangible shells are configured to rupture and release the first type payload responsive to a first type activation action being applied to the activation region and contain the first type payload prior to first type activation action being applied to the activation region. The first type payload includes a first type liquefiable material configured to liquefy responsive to a first type of predetermined environmental exposure, the first type payload having a first viscosity when the first type liquefiable material is liquefied. After being released from the first type frangible shells and when the first type liquefiable material is liquefied, the first type payload is configured to flow from the activation region into the indicator region and produce a first observable effect in the indicator region after a first predetermined period of time. The second type frangible shells are configured to rupture and release the second type payload responsive to a second type activation action being applied to the activation region and remain intact and contain the second type payload when the first type activation action is applied to the activation region, prior to the second type activation action being applied to the activation region. The second type payload includes a second type liquefiable material configured to liquefy responsive to the predetermined environmental exposure, the second type payload having a second viscosity when the second type liquefiable material is liquefied. After being released from the second type frangible shells and responsive to the predetermined environmental exposure, the second type payload is configured to flow from the activation region into the indicator region and produce a second observable effect in the indicator region after a second predetermined period of time, the second predetermined period of time being greater than the first predetermined period of time. The first type frangible shells are configured to remain intact and contain the first type payload when the second type activation action is applied.

In an example embodiment, the present disclosure describes an activatable environmental exposure indicator, including a substrate, an indicator region defined on, or operatively coupled to the substrate, an activation region in fluid communication with the indicator region, a plurality of first type microcapsules disposed in the activation region, each first type microcapsule of the plurality of first type microcapsules including a first type payload microencapsulated in a first type frangible shell, and a plurality of second type microcapsules disposed in the activation region, each second type microcapsule of the plurality of second type microcapsules including a second type payload microencapsulated in a second type frangible shell. The first type frangible shells are configured to rupture and release the first type payload responsive to a first type activation action being applied to the activation region and contain the first type payload prior to the first type activation action being applied to the activation region. The first type payload includes a first type liquefiable material configured to liquefy responsive to a first predetermined environmental exposure. After being released from the first type frangible shells and when the first type liquefiable material is liquefied, the first type payload is configured to migrate from the activation region into the indicator region and produce a first observable effect in the indicator region. The second type frangible shells are configured to rupture and release the second type payload responsive to a second type activation action being applied to the activation region, and remain intact and contain the second type payload when the first type activation action is applied to the activation region and prior to the second type activation action being applied to the activation region. The second type payload includes a second type liquefiable material configured to liquefy responsive to a second predetermined environmental exposure. After being released from the second type frangible shells and responsive to the second predetermined environmental exposure, the second type payload is configured to migrate from the activation region into the indicator region and produce a second observable effect in the indicator region. The first type frangible shells are configured to remain intact and contain the first type payload when the second activation action is applied.

In an example embodiment, the technology of the present disclosure may be provided by a method of forming an activatable environmental exposure indicator, the method including providing a substrate including an activation region in fluid communication with an indicator region, providing a plurality of first type microcapsules, each first type microcapsule including a first type payload material microencapsulated in a first type frangible shell, providing a plurality of second type microcapsules, each second type microcapsule including a second type payload microencapsulated in a second type frangible shell, and depositing the plurality of first type microcapsules and the plurality of second type microcapsules in the activation region. The first type payload material includes a first type liquefiable material configured to liquefy responsive to a predetermined environmental exposure and have a first viscosity when liquefied. The second type payload includes a second type liquefiable material, configured to liquefy responsive to the predetermined environmental exposure and have a second viscosity when liquefied. The first type frangible shells are configured to rupture and release the first type payload when a first activation action is applied to the activation region. Thee second type frangible shells are configured to rupture and release the second type payload when a second activation action is applied to the activation region. The first type frangible shells are configured to remain intact and contain the first type payload when the first type liquefiable material is liquefied, when the first type liquefiable material is solidified, and when the second activation action is applied to the activation region, prior to the first activation action being applied to the activation region. The second type frangible shells are configured to remain intact and contain the second type payload when the second type liquefiable material is liquefied, when the second type liquefiable material is solidified and when the first activation action is applied to the activation region, prior to the second activation action being applied to the activation region.

In a variation one or more of the example embodiments, after the first type payload is released from the first type frangible shells and liquefied, the first type liquefiable material is configured to solidify when not exposed to the predetermined environmental exposure, such that flow of the first type payload to the indicator region is halted when the predetermined environmental exposure ceases and flow of the first type payload to the indicator region resumes when the predetermined environmental exposure resumes, such that the first predetermined period of time is an amount of time for which the first type payload is exposed to the predetermined environmental exposure.

In a variation one or more of the example embodiments, the first observable effect and the second observable effect are a same observable effect.

In a variation one or more of the example embodiments, after the second type payload is released from the second type frangible shells and liquefied, the second type liquefiable material is configured to solidify when not exposed to the predetermined environmental exposure, such that flow of the second type payload to the indicator region is halted when the predetermined environmental exposure ceases and flow of the second type payload to the indicator region resumes when the predetermined environmental exposure resumes, such that the second predetermined period of time is an amount of time for which the second type payload is exposed to the predetermined environmental exposure.

In a variation one or more of the example embodiments, the first type activation action and the second type activation action are applied to the activation region, and responsive to the predetermined environmental exposure, the first type payload and the second type payload liquefy and combine, forming a combined material having a third viscosity, the combined material configured flow from the activation region into the indicator region and produce the observable effect after a third predetermined period of time.

In a variation one or more of the example embodiments, when the combined material is formed and liquefied, the combined material is configured to solidify when not exposed to the predetermined environmental exposure, such that flow of the combined material to the indicator region is halted when the predetermined environmental exposure ceases and flow of the combined material to the indicator region resumes when the predetermined environmental exposure resumes, such that the third predetermined period of time is an amount of time for which the combined material is exposed to the predetermined environmental exposure, the third time being distinct from the first predetermined period of time or the second predetermined period of time.

In a variation one or more of the example embodiments, one of the first type activation action and the second type activation action is a heat exposure above a predetermined activation threshold.

In a variation one or more of the example embodiments, one of the first type activation action and the second type activation action is compression or shear stress exceeding a predetermined stress threshold.

In a variation one or more of the example embodiments, the second predetermined period of time is between 1.1 times and 5 times longer than the first predetermined period of time.

In a variation one or more of the example embodiments, the first type payload contains a first indicator material configured to produce the first observable effect in the indicator region.

In a variation one or more of the example embodiments, the second type payload contains a second indicator material configured to produce the second observable effect in the indicator region.

In a variation one or more of the example embodiments, the first type payload contains a first indicator material and the observable effect in the indicator region is a first observable effect, and the second type payload contains a second indicator material and the observable effect in the indicator region is a second observable effect, distinct from the first observable effect.

In a variation one or more of the example embodiments, one or both of the first type frangible shells and the second type frangible shells are formed from a material selected form a group consisting of polyurethane, polylactic acid, ethyl cellulose, poly(lactic-co-glycolic acid), poly(methyl methacrylate), nylon, silicone elastomers, natural rubber, polymelamine formaldehyde, polyurea formaldehyde, styrene-butadiene rubber, polybutadiene rubber, nitrile butadiene rubber, silica, calcium carbonate, alumina, borosilicate glass, zinc oxide and combinations thereof.

In a variation one or more of the example embodiments, one or both of the first type frangible shells and the second type frangible shells are formed from a material selected form a group consisting of polyethylene, polyvinyl alcohol, polyurethane, polystyrene, poly(methyl methacrylate), poly(lactic-co-glycolic acid), polycaprolactone, polypropylene, nylon, ethylene vinyl acetate, cellulose acetate, poly(ethylene glycol), a polyamide/urea hybrid, paraffin wax, microcrystalline wax, carnauba wax, Montan wax, polyethylene wax, candelilla wax, fischer-tropsch wax, and combinations thereof.

In a variation one or more of the example embodiments, one or both of the first type frangible shells and the second type frangible shells have shell thicknesses in a range of 2 to 700 micrometers (μm).

In a variation one or more of the example embodiments, one or both of the of the of first type microcapsules and second type microcapsules includes a volatile material microencapsulated along with the respective payload, the volatile material configured to expand responsive to the respective activation action, rupturing the respective frangible shells.

In a variation one or more of the example embodiments, the predetermined environmental exposure is selected from a group consisting of a temperature excursion above a predetermined temperature threshold, temperature excursion below a predetermined temperature threshold, an exposure to a particular chemical, an oxygen exposure, an ammonia exposure, an exposure to a particular chemical above a threshold concentration, an exposure to at least a predetermined amount of radiation of a particular type, a predetermined electromagnetic exposure, a humidity exposure, and an exposure to a humidity level above a predetermined threshold.

In a variation one or more of the example embodiments, one or both of the first observable effect and the second observable effect is a change in an apparent color state of at least a portion of the indicator region resulting from the one or both of the first type payload and the second type payload reaching the portion of the indicator region.

In a variation one or more of the example embodiments, one or both of the first type payload and the second type payload contains an indicator material configured to change the apparent color state of the indicator region, the indicator material selected from a group consisting of a dye, a colorant, an ink, a first reactant configured to react with a second reactant disposed in the indicator region to produce a color state change, a reflective material, a flash material configured to give a bright appearance when illuminated with light of a predetermined wavelength, and combinations thereof.

In a variation one or more of the example embodiments, one or both of the first observable effect and the second observable effect is a change in an electrical property of the indicator region as detected by a circuit connected to the indicator region, wherein the electrical property is selected from a group consisting of conductivity, resistivity, impedance, capacitance, and inductance and a respective of the first type payload and the second type payload includes a plurality of conductive particles configured to change the electrical property of the indicator region, the plurality of conductive particles selected from a group consisting of particles containing copper, particles containing silver, particles containing graphite, particles containing graphene, particles containing graphene oxide, particles containing other functionalized graphenes, particles containing conductive metals, particles containing conductive non-metal materials, electroconductive carbon black, and combinations thereof.

In a variation one or more of the example embodiments, the first type payload includes a first reactant, and the indicator region includes a second reactant, and when the first type payload reaches the indicator region, the first reactant has a reaction with the second reactant to form a product, wherein one of the reaction and the product produces the first observable effect in the indicator region.

In a variation one or more of the example embodiments, the second type payload includes a first reactant, and the indicator region includes a second reactant, and when the second type payload reaches the indicator region, the first reactant has a reaction with the second reactant to form a product, wherein one of the reaction and the product produces the second observable effect in the indicator region.

In a variation one or more of the example embodiments, the indicator region and the activation region are in fluid communication via a connector component is selected from a group consisting of a wick, a plurality of capillary tubes, a plurality of microchannel, and combinations thereof.

In a variation one or more of the example embodiments, the first predetermined environmental exposure is an exposure to a temperature above a first temperature threshold, and the second predetermined environmental exposure is an exposure to a temperature above a second temperature threshold, the second temperature threshold exceeding the first temperature threshold.

In a variation of this embodiment, after the first type payload is released from the first type frangible shells, and when the first type liquefiable material is liquefied, the first type payload has a first viscosity and produces the observable effect in the indicator region after a first predetermined period of time, and after the second type payload is released from the second type frangible shells and when the second type liquefiable material is liquefied, the second type payload has a second viscosity and produces the observable effect in the indicator region after a second predetermined period of time.

In a variation one or more of the example embodiments, the first predetermined environmental exposure is an exposure to a temperature above a first temperature threshold, after the first type payload is released from the first type frangible shells, and when the first type liquefiable material is liquefied, the first type payload has a first viscosity and produces the observable effect in the indicator region after a first predetermined period of time, and the second predetermined environmental exposure is an exposure to a temperature above a second temperature threshold, the second temperature threshold exceeding the first temperature threshold and after the second type payload is released from the second type frangible shells and when the second type liquefiable material is liquefied, the second type payload has a second viscosity and produces the observable effect in the indicator region after a second predetermined period of time, the second predetermined period of time being less than the first predetermined period of time.

In a variation one or more of the example embodiments, the first type payload contains a first indicator material and the observable effect in the indicator region is a first observable effect, and the second type payload contains a second indicator material and the observable effect in the indicator region is a second observable effect, distinct from the first observable effect.

In a variation one or more of the example embodiments, after being released from the first type frangible shells and when the first type liquefiable material is liquefied, the first type payload is configured to flow from the activation region into the indicator region and produce an observable effect in the indicator region after a first predetermined period of time, and after being released from the second type frangible shells and responsive to the predetermined environmental exposure, the second type payload is configured to flow from the activation region into the indicator region and produce the observable effect in the indicator region after a second predetermined period of time.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed technology and explain various principles and advantages of those embodiments.

FIG. 1 illustrates a microcapsule, according to embodiments of the present disclosure.

FIG. 2 illustrates a first general embodiment of an activatable environmental exposure indicator, according to embodiments of the present disclosure.

FIG. 3A illustrates a first type microcapsule deployed in the activatable environmental exposure indicator of FIG. 2, according to embodiments of the present disclosure.

FIG. 3B illustrates a second type microcapsule deployed in the activatable environmental exposure indicator of FIG. 2, according to embodiments of the present disclosure.

FIGS. 4A-4C illustrate various stages of the activatable environmental exposure indicator of FIG. 2, according to embodiments of the present disclosure.

FIGS. 5A-D illustrate views of an example activatable environmental exposure indicator configured for an example use case scenario, according to embodiments of the present disclosure. views and stages of a second general embodiment of an activatable environmental exposure indicator, according to embodiments of the present disclosure.

FIGS. 6A-6C illustrate views of a second general embodiment of an activatable environmental exposure indicator, according to embodiments of the present disclosure.

FIG. 7 illustrates a flowchart for a method of forming activatable environmental exposure indicators, according to embodiments of the present disclosure.

FIG. 8 illustrates a flowchart for a method of use for activatable environmental exposure indicators, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present technology.

The apparatus and method components have been represented where appropriate by conventional symbols in the drawings, showing only those specific details that are pertinent to understanding the embodiments of the present technology so as not to obscure the disclosure with details that will be readily apparent to those of ordinary skill in the art having the benefit of the description herein.

### DETAILED DESCRIPTION

The technology of the present disclosure is related to activatable environmental exposure indicators which have tailorable response conditions which are selectable by an end user. In previously proposed activatable environmental exposure indicators, each indicator is configured to indicate, after activation, an occurrence of a one particular type of environmental exposure. Certain previously proposed indicators are capable of indicating multiple exposures or exposure types, but these designs typically incorporate multiple separate indicators which may be jointly housed but are functionally separated. The activatable environmental exposure indicators of the present disclosure utilize multiple distinct types of indicator materials, or payloads, contained in distinct types of microcapsules which have distinct activation conditions and distinct environmental exposure indication conditions. By applying a particular activation action, a corresponding subset of microcapsules release an indicator material which is configured to indicate a first particular type of environmental exposure when the first particular type of environmental exposure subsequently occurs. Alternatively, by applying different type of activation action, a different subset of microcapsules releases an indicator material configured to indicate a second particular type of environmental exposure, when the second type of environmental exposure subsequently occurs. The microcapsules may be contained together, and may even be intermingled, and regardless of which microcapsules are activated, the same indicator hardware, such as migration regions and indicator regions, may be utilized by the indicator material which is released.

The discussion contained in the following detailed description has been organized as follows:
Section I: Some Relevant Materials and Notable Properties Thereof.
Section II: Rupturable Microcapsules
Section III: Embodiments of Activatable Environmental Exposure Indicators.

### Section I: Some Relevant Materials and Notable Properties Thereof

### Liquefiable Materials

Various embodiments of activatable environmental exposure indicators discussed herein utilize a liquefiable material that can be configured to react to an environmental exposure, such as temperature, humidity, gas exposure or the like. In particular, in many embodiments the liquifiable materials responds by liquifying in response to temperature above a predetermined threshold relatively quickly. This is because the liquefiable material of some embodiments is configured or selected to have a sharp melting point, such that liquefaction happens very quickly over a small temperature range. Thus, exposure to a predetermined environmental exposure, e.g., a peak temperature exceeding the melting point of the liquefiable material, causes a quick state change. With regard to the rapidity or quickness of state changes, the materials discussed herein which are suitable for the disclosed applications preferably have melting range or glass transition spanning less than 10 degrees C., more preferably spanning less than 5 degrees C., and most preferably spanning 1 degree C. or less.

In addition to transitioning from a solid phase to a liquid phase over a small temperature range, some suitable materials discussed herein transition from a liquid phase to a solid phase over a similarly small temperature range. Once the environmental exposure temperature has been exceeded, a drop in temperature below the environmental exposure will cause almost immediate solidification of the liquefiable material.

As used herein, the term “liquid phase” is used to describe a state of a material in which the material is capable of fluid flow. Similarly, the terms “liquefaction” and “liquefy” and other variations across parts of speech, are used to describe the transition in which a material not in the liquid phase enters the liquid phase. The terms “liquefaction point” and “liquefaction temperature” are used to describe a temperature, or temperature range, at or in which a material may undergo liquefaction.

As used herein, the term “solid phase” may refer to a material in a non-liquid state such that the material is incapable of fluid flow. In some examples “solid phase” may refer to a gelled state, a highly viscous state, a true solid state, and the like. Similarly, the terms “solidification” and “solidify” are used to describe the transition in which a material not in the solid phase enters the solid phase. The terms “solidification point” and “solidification temperature” are used to describe a temperature, or temperature range, at or in which a material may undergo solidification.

As used herein, the term “predetermined environmental exposure” is used to describe an exposure to an environmental or ambient condition exceeding (e.g., either positively or negatively) a known or otherwise predetermined exposure threshold. In various embodiments, a predetermined environmental exposure may be an exposure to a temperature exceeding a predetermined temperature threshold. Various liquefiable materials discussed herein are configurable such that the liquefiable material liquefies responsive to a predetermined environmental exposure. In some embodiments, one or more liquefiable materials which liquefy at a particular temperature corresponding to a predetermined environmental exposure may be selected for use in the disclosed applications, and in other examples, liquefiable materials may be modified or formulated such that the liquefiable material liquefies at a particular temperature corresponding to the predetermined environmental exposure.

According to some embodiments, some liquefiable materials may have a shared liquefaction point and solidification point, in which the liquefiable material liquefies and solidifies about temperature range less than 1 degree C. In other examples, the liquefiable materials discussed herein may exhibit hysteresis, where the solidification temperature is substantially lower (e.g., more than 1 degree C.) than the liquefication temperature. In some embodiments, the liquefaction and solidification temperatures are within about 0.1 degrees C., within about 0.5 degrees C., within about 1.0 degrees C., within about 1.5 degrees C., within about 2 degrees C., within about 2.5 degrees C., within about 3.0 degrees C., within about 3.5 degrees C., within about 4.0 degrees C., within about 4.5 degrees C., within about 5 degrees C., or within about 10 degrees C. of each other.

Suitable liquefiable materials include synthetic polymeric materials that are solid below the threshold temperature and are, or can become, a flowing amorphous solid or a viscous liquid when at and/or above a threshold temperature. Such synthetic polymeric materials are liquefiable. Useful synthetic polymers can also be hydrophobic, if desired. Suitable liquefiable materials include side-chain crystallizable polymers (e.g., various particular methacrylates, such as poly(hexadecylmethacrylate); a polymer or a copolymer having at least one crystallizable side chain selected from the group consisting of a C4-30 aliphatic group; a C6-30 aromatic group; a linear aliphatic group having at least 10 carbon atoms; a combination of at least one aliphatic group and at least one aromatic group, the combination having from 7 carbon atoms to about 30 carbon atoms; a C10-C22 acrylate; a C10-C22 methacrylate; an acrylamide; a methacrylamide; a vinyl ether; a vinyl ester; a fluorinated aliphatic group having at least 6 carbon atoms; and a p-alkyl styrene group wherein the alkyl group has from about 8 carbon atoms to about 24 carbon atoms.).

As used herein, the term “polymer”, and its linguistic variations, refers to copolymers, and higher order polymers, as well as homopolymers, unless the context indicates otherwise, for example, by describing or referencing one or more specific homopolymers.

When solid, the synthetic polymeric material can be crystalline or partially crystalline. Crystalline or partially crystalline synthetic polymeric materials can have desirably sharp transitions from a solid state to a liquid state.

Side chain (liquid) crystalline polymers (abbreviated as SCC hereafter) are particularly suitable liquefiable materials, though other suitable materials such as waxes could readily be used. SCC polymers have a conventional polymer backbone and side chains that can co crystallize. Typically, they are chains that have six or more carbons with a crystallization temperature that is, therefore, adjustable. In some embodiments, the side chains “melt” independently of the main polymer chain so that the phenomenon can be used to release other materials that have been encapsulated within the overall polymer structure. Another advantage of SCC polymers is that their molecular weight and degree of crosslinking can be adjusted to control their physical properties including their permeability and in turn provide an approach to tailor the time delay.

Some examples of SCC polymers include poly(dodecylacrylate), poly(tetradecylacrylate) , poly(hexadecylacrylate), poly(octadecylacrylate), copolymer of hexylacrylate and dodecylacrylate, copolymer of hexylacrylate and docosylacrylate, copolymer of decylacrylate and tetradecylacrylate, copolymer of decylacrylate and octadecylacrylate, copolymer of decylacrylate and octadecylacrylate, copolymer of decylacrylate and octadecylacrylate, copolymer of dodecylacrylate and docosylacrylate, copolymer of dodecylacrylate and docosylacrylate, copolymer of dodecylacrylate and docosylacrylate, copolymer oftetradecylacrylate and octadecylacrylate, copolymer oftetradecylacrylate and octadecylacrylate, copolymer oftetradecylacrylate and octadecylacrylate, poly(dodecylmethacrylate), poly(tetradecylmethacrylate), poly(hexadecylmethacrylate), poly(octadecylmethacrylate), copolymer of tetradecylmethacrylate and methyl methacrylate, copolymer of octadecylmethacrylate and methyl methacrylate.

For example, the liquefiable material may be a side-chain crystallizable polymer combined with an alkane wax. Some side-chain crystallizable (SCC) polymers useful in the practice of the present disclosure, alone or in combination, and methods that can be employed for preparing them, are described in O'Leary et al. “Copolymers of poly(n-alkyl acrylates): synthesis, characterization, and monomer reactivity ratios” in Polymer 2004 45 pp 6575-6585 (“O'Leary et al.” herein), and in Greenberg et al. “Side Chain Crystallization of n-Alkyl Polymethacrylates and Polyacrylates” J. Am. Chem. Soc., 1954, 76 (24), pp. 6280-6285 (“Greenberg et al.” herein). The disclosure of each of O'Leary et al. and Greenberg et al. is incorporated by reference herein for all purposes.

Side-chain crystallizable polymers, sometimes called “comb-like” polymers, are well-known and available commercially. These polymers are reviewed in J. Polymer Sci. Macromol. Rev. 8:117-253 (1974), the disclosure of which is hereby incorporated by reference. In general, these polymers contain monomer units X of the formula:

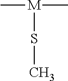

where M is a backbone atom, S is a spacer unit and C is a crystallizable group. These polymers have a heat of fusion (ΔH_{f}) of at least about 20 Joules/g, preferably at least about 40 Joules/g. The polymers will contain about 50 to 100 percent monomer units represented by “X”. If the polymer contains less than 100 percent X, in addition contain monomer units which may be represented by “Y” or “Z”, or both, wherein Y is any polar or nonpolar monomer or mixture of polar or nonpolar monomers capable of polymerizing with X and/or Z, and wherein Z is a polar monomer or mixture of polar monomers. Polar groups, e.g., polyoxyalkylenes, acrylates including hydroxyethylacrylate, acrylamides including methacrylamide-will typically increase adhesion to most substrates. If the polar species “Z” is acrylic acid, it is preferred that it comprise about 1-10 wt. percent of the polymer.

The backbone of the polymer (defined by “M”) may be any organic structure (aliphatic or aromatic hydrocarbon, ester, ether, amide, etc.) or an inorganic structure (sulfide, phosphazine, silicone, etc.), and may include spacer linkages which can be any suitable organic or inorganic unit, for example ester, amide, hydrocar bon, phenyl, ether, or ionic salt (e.g., a carboxyl-alkyl ammonium or sulphonium or phosphonium ion pair or other known ionic salt pair).

The side-chain (defined by ‘S’ and ‘C’) may be aliphatic or aromatic or a combination of aliphatic and aromatic, but must be capable of entering into a crystal line state. Common examples are: linear aliphatic side chains of at least 10 carbon atoms, e.g., C₄-C₂₂ acrylates or methacrylates, acrylamides or methacrylamides, vinyl ethers or esters, siloxanes or alpha olefins; fluorinated aliphatic side-chains of at least 6 carbons; and p-alkyl styrene side-chains wherein the alkyl is of 8 to 24 carbon atoms.

The length of the side-chain moiety is usually greater than 5 times the distance between side-chains in the case of acrylates, methacrylates, vinyl esters, acrylamides, methacrylamides, vinyl ethers and alpha olefins. In the extreme case of a fluoroacrylate alternate copolymer with butadiene, the side-chain can be as little as two times the length as the distance between the branches.

In any case, the side-chain units should make up greater than 50 percent of the volume of the polymer, preferably greater than 65 percent of the volume. Specific examples of side-chain crystallizable monomers are the acrylate, fluoroacrylate, methacrylate and vinyl ester polymers described in J. Poly. Sci 10:3347 (1972); J. Poly. Sci 10:1657 (1972); J. Poly. Sci 9:3367 (1971); J. Poly. Sci 9:3349 (1971); J. Poly. Sci. 9:1835 (1971); J.A.C.S. 76:6280 (1954); J. Poly, Sci 7:3053 (1969); Polymer J. 17:991 (1985), corresponding acryl amides, substituted acrylamide and maleimide polymers (J. Poly. Sci: Poly. Physics Ed. 18:2197 (1980)); polyalphaolefin polymers such as those described in J. Poly. 5,156,911 7 Sci. Macromol. Rey, 8:117-253 (1974) and Macromolecules 13:12 (1980), polyalkylvinylethers, polyalkylethylene oxides such as those described in Macromolecules 13:15 (1980), alkylphosphazene polymers, polyamino acids such as those described in Poly. Sci. USSR 21:241, Macromolecules 18:2141, polyisocyanates such as those described in Macromolecules 12:94 (1979), polyurethanes made by reacting amine-or alcohol-containing monomers with long-chain alkyl isocyanates, polyesters and polyethers, polysiloxanes and polysilanes such as those described in Macromolecules 19:611 (1986), and p-alkylstyrene polymers such as those described in J.A.C.S. 75:3326(1953) and J. Poly. Sci 60:19 (1962). Of specific utility are polymers which are both relatively polar and capable of crystallization, but wherein the crystallizing portion is not affected by moisture. For example, incorporation of polyoxyethylene, polyoxy propylene, polyoxybutylene or copolyoxyalkylene units in the polymer will make the polymer more polar.

In a particularly preferred embodiment herein, in the above structure, —C is selected from the group consisting of —(CH₂)—CH₃ and —(CF₂)ₙ—CF₂H, where n is an integer in the range of 8 to 20 inclusive, —S— is selected from the group consisting of —O—, —CH₂—, —(CO)—, —O(CO)— and —NR— where R is hydrogen or lower alkyl (1-6C), and —M— is —[(CH₂)ₘ—CH]— where m is 0 to 2.

Typical “Y” units include linear or branched alkyl or aryl acrylates or methacrylates, alpha olefins, linear or branched alkyl vinyl ether or vinyl esters, maleicesters or itaconic acid esters, acrylamides, styrenes or substituted styrenes, acrylic acid, methacrylic acid and hydrophilic monomers as detailed in WO84/0387, cited supra.

Some useful side-chain crystallizable polymers, and monomers for preparing side-chain crystallizable polymers, are also available from commercial suppliers, for example, Scientific Polymer Products, Inc., Ontario, N.Y., Sigma-Aldrich, Saint Louis, Mo., TCI America, Portland Oreg., Monomer-Polymer & Dajac Labs, Inc., Trevose, Pa., San Esters Corp., New York, N.Y., Sartomer USA, LLC, Exton Pa., and Polysciences, Inc.

The liquefiable materials which are suitable for deployment in the disclosed applications may be further selected or configured for particular properties when liquefied, such as viscosity, a s a non-limiting example. Generally, viscosity of a liquified material (e.g., liquefied liquefiable material) corresponds to molecular weight of the molecules in the liquefied material. As such, a liquefiable material may be selected or configured to have a particular molecular weight in order to achieve a particular viscosity when liquefied.

With regard to SCC materials in particular, the melting point of SCC materials may be tuned by increasing the side-chain length of the molecules of the SCC material, and the viscosity (when liquefied) may be tuned by increasing the quantity of side chains of the molecules of the SCC material, thus increasing the molecular weight.

In addition to SCC polymers, suitable liquefiable materials for the disclosed applications may include non-SCC polymers, polymeric waxes, synthetic waxes, natural waxes and combinations thereof.

According to some embodiments, a first liquefiable material may be combined with a second liquefiable material to form a combined liquefiable material which has a liquefication point distinct from the liquefication points of either the first or second liquefiable materials.

According to some embodiments, a first liquefiable material may be combined with a second liquefiable material to form a combined liquefiable material which has a viscosity when liquefied which is distinct from that of either the first or second liquefiable materials.

According to some embodiments, various liquefiable materials may have shared properties and unshared properties. For example, a first liquefiable material and a second liquefied material may have shared liquefaction points and have distinct viscosities when liquefied. Conversely, a third liquefiable material and a fourth liquefiable material may have identical viscosities when liquefied but have distinct liquefication points.

Various liquefiable materials suitable for use in the disclosed applications may have melting points or liquefaction points across a broad range of temperatures. Useful liquefiable materials may have a melting point or liquefaction point between 0 degrees C. and 100 degrees C., although temperatures above 100 degrees C. and below 0 degrees C. are also contemplated.

### Frangible Shells

Various embodiments of activatable environmental exposure indicators discussed herein utilize microcapsules having frangible shells, which are employed to microencapsulate a payload of other materials (e.g., liquefiable materials and indicator materials), forming a microcapsule. The frangible shells are rupturable, such that the frangible shells rupture and release the payload when subjected to an activation action.

The microcapsule is initially in an unruptured form, capable of being configured to transition to a ruptured form when ruptured by exposure to an activation action, (e.g., the application of heat, pressure, and/or a combination of heat and pressure exceeding a predetermined threshold). In the unruptured form, the frangible shell of the microcapsule maintains separation between the contents of the microcapsule and any external environmental stimuli and/or contains a phase change of the contents of the microcapsule in response to any external environmental stimuli. Prior to activation (e.g., exposure to the activation action), the frangible shells of a microcapsule contain the payload of the microcapsule when the payload is liquefied, solidified, undergoing a phase change, and in any other material states the payload may experience in the usable ranges of the devices of the present disclosure.

The frangible shell may be ruptured by applying an activation action to the microcapsule exceeding a predetermined activation threshold. The activation action may cause the frangible shell to fracture, melt, break, dissolve, sublime, become porous, or otherwise disengage, allowing the release of the contents of the frangible shell, generally referred to herein as “rupturing”.

The frangible shells may have one or more of various rupture modes (or weakening modes), to which the activation action or actions correspond. Each activation action may be configured to have a predetermined activation threshold at which the microcapsule is configured to rupture. In some examples, each activation action may be configured to have a predetermined activation threshold at which the frangible shell of the microcapsule is weakened (but not ruptured) to a predetermined extent, such that the predetermined activation threshold of a second activation action necessary to rupture the microcapsule is lowered (when compared to the predetermined activation threshold of the second activation alone). Said differently, a first activation action may lower an energy requirement of a second activation action that later activates the microcapsule.

A first rupture mode is rupture or weakening by externally applied pressure. In some examples, the microcapsules may be ruptured by a source of external pressure, where the activation action is an exposure to a compressive or shearing force. The frangible shells may be configured such that the predetermined activation threshold corresponds to a compression stress or a shear stress of sufficient magnitude to rupture the frangible shell. In some examples, the predetermined stress threshold is a compressive stress or a shearing stress exceeding about 0.1 pounds per square inch (psi), a compressive stress or a shearing stress exceeding about 0.5 psi, a compressive stress or a shearing stress exceeding about 1 psi, a compressive stress or a shearing stress exceeding about 2 psi, a compressive stress or a shearing stress exceeding about 5 psi, a compressive stress or a shearing stress exceeding about 10 psi, or a compressive stress or a shearing stress exceeding about 15 psi. The activation stress ranges given are purely exemplary and the microcapsules can be formed to respond to other stress ranges.

A second rupture mode is rupture or weakening by heat exposure. In some examples, the microcapsules may be ruptured or weakened by a source of heat, where the activation action is an exposure to a temperature configured to melt, degrade, decrease the structural integrity of, or otherwise disengage the frangible shell. In some such examples, the predetermined activation threshold may correspond to a temperature exceeding about 35 degrees C., a temperature exceeding about 40 degrees C., a temperature exceeding about 45 degrees C., a temperature exceeding about 50 degrees C., a temperature exceeding about 55 degrees C., a temperature exceeding about 60 degrees C., a temperature exceeding about 65 degrees C., a temperature exceeding about 70 degrees C, a temperature exceeding about 75 degrees C., a temperature exceeding about 80 degrees C., a temperature exceeding about 85 degrees C., a temperature exceeding about 90 degrees C., a temperature exceeding about 95 degrees C., and a temperature exceeding about 100 degrees C. The activation heat ranges given are purely exemplary and the microcapsules can be formed to respond to other temperature ranges.

In some such examples, activation may be achieved by applying a high temperature for a very short interval, e.g., a few milliseconds. For example, the mass or heat of fusion of the payload may be much greater than the mass or heat of fusion of a barrier that needs to be removed, allowing a short exposure to high temperature to remove or alter the microcapsule without significantly affecting a thermally sensitive payload contained in the microcapsule.

A third rupture mode is rupture or weakening resulting from an internally applied pressure. In some such examples, the microcapsules may be ruptured or weakened by a source of internal pressure, where the activation action is configured to trigger expansion of a material within the frangible shell (e.g., a volatile material, thermally expandable microsphere) which increases the internal pressure of the microcapsule, which ruptures or weakens the frangible shell.

In some such examples, the predetermined activation threshold corresponds to a radial stress or a hoop stress (e.g., acting on the frangible shell) of sufficient magnitude to rupture the frangible shell. In some examples, the predetermined activation stress threshold is a radial stress or hoop stress exceeding about 0.1 pounds per square inch (psi), a radial stress or hoop stress exceeding about 0.5 psi, a radial stress exceeding about 1 psi, a radial stress exceeding about 2 psi, a radial stress or hoop stress exceeding about 5 psi, a radial stress or hoop stress exceeding about 10 psi, or a radial stress or hoop stress exceeding about 15 psi. The activation stress ranges given are purely exemplary and the microcapsules can be formed to respond to other stress ranges.

Microcapsules which are configured to rupture via the first mode, externally applied pressure, may be formed of one or more of several materials and from one or more of several processes in order to meet user specifications. Generally, materials suitable for forming frangible shells which are configured to rupture via the first mode are categorizable into three groups, including polymers, elastomers and inorganics.

Some polymers suitable for forming frangible shells which are configured to rupture via the first mode are listed below, as nonlimiting examples.
Polyurethane (PU): PU is generally flexible, and resilient to pressure, and the pressure sensitivity can be tailored to various use cases through alterations in formulation.
Polylactic Acid (PLA): PLA is generally brittle, and the pressure sensitivity can be tailored to various use cases by increasing or decreasing the degree of crystallinity. An additional benefit is that PLA is biodegradable.
Ethyl Cellulose: ethyl cellulose has good film forming properties, and is modifiable for specific mechanical responses, such as abrasion, puncture, and crushing.
Poly(lactic-co-glycolic acid) (PLGA): PLGA has tunable mechanical properties and the pressure sensitivity is tailorable through alterations in formulation.
Poly(methyl methacrylate) (PMMA): PMMA is brittle under mechanical stress, relatively transparent, and the pressure sensitivity is tailorable through adjustment of shell thickness.
Polyamides (Nylon): Nylon has high strength and resilience, and pressure sensitivity varies by species and can be tailored though alterations in formulation and processing. Polyamide/urea hybrids may also be suitable.
Polymelamine Formaldehyde: Polymelamine formaldehyde is hard and brittle, and specific burst pressures are application specific.
Polyurea Formaldehyde: Polyurea formaldehyde is hard and brittle, and pressure sensitivity varies with crosslinking density.

Some elastomers suitable for forming frangible shells which are configured to rupture via the first mode are listed below, as nonlimiting examples.
Silicone elastomers: silicone elastomers are highly flexible, with high elasticity, and can be engineered for specific pressure sensitivities.
Natural rubber: natural rubber has good elasticity and flexibility; pressure sensitivity can be adjusted via cross-linking and formulation.
Styrene-Butadiene Rubber (SBR): SBR has good abrasion resistance, modifiable for different pressure thresholds.
Polybutadiene rubber: polybutadiene rubber has high resilience, good impact resistance, may be blended to adjust pressure sensitivity.
Nitrile Butadiene Rubber (NBR): NBR has good oil and chemical resistance and is customizable for specific mechanical properties.

Some inorganics suitable for forming frangible shells which are configured to rupture via the first mode are listed below, as nonlimiting examples.
Silica: silica can form brittle shells which have a high thermal stability.
Calcium Carbonate: Calcium carbonate may be used as a filler to modify mechanical properties and contributes to brittle rupture behavior.
Alumina (Aluminum Oxide): Alumina has high mechanical strength, can be brittle, and may be useful in rigid shell applications.
Borosilicate Glass: Borosilicate glass is brittle under stress and has high thermal and chemical resistance.
Zinc Oxide: Zinc Oxide is brittle under pressure, and also offers UV protection when used in coatings.

In the above examples, material selection is dependent on payload material so as for chemical interactions to be avoided. Then, specific burst pressures are highly dependent on the thickness of the shell paired with the degree of crosslinking. Additionally, tailoring the molecular weight and introducing other materials to the formulation, such as plasticizers or fillers can adjust the burst pressure. Due to the extent of independent variables, experimental determination is required to establish exact burst pressures.

Microcapsules which are configured to rupture via the first mode, externally applied pressure, may be formed of one or more of several materials and from one or more of several processes in order to meet user specifications. Several non-limiting examples are given below.

Spray drying, which involves atomizing a solution or suspension of the shell material and core material into a hot chamber, where rapid solvent evaporation forms solid microspheres. The mechanical properties may be controlled by the composition and processing parameters.

Emulsion polymerization, in which monomers are emulsified in a continuous phase and polymerized to form microspheres. The mechanical properties of the shell can be tailored by selecting appropriate monomers and crosslinking agents.

Coacervation/Phase Separation is a process where a polymer-rich phase separates from a polymer-poor phase to encapsulate the core material. Solidification of this phase forms microspheres with controllable mechanical properties.

Solvent Evaporation, in which the polymer and core material are dissolved in a volatile organic solvent, then emulsified in an aqueous phase. As the solvent evaporates, microspheres with specific mechanical properties are formed.

Interfacial Polymerization in which polymerization occurs at the interface between two immiscible phases, forming a polymer shell around the core material. The thickness and composition of the shell can be controlled to influence its rupture characteristics.

Microfluidics is precise technique where droplets are formed in microfluidic devices and solidified to form microspheres. This provides for precise control over the size and mechanical properties of the microspheres.

Microcapsules which are configured to rupture via the second mode, heat exposure, may be formed of one or more of several materials and from one or more of several processes in order to meet user specifications. Generally, materials suitable for forming frangible shells which are configured to rupture via the heat exposure are categorizable into three groups, including polymers, waxes and inorganics.

Some polymers suitable for forming frangible shells which are configured to rupture via the second mode are listed below, as nonlimiting examples. Many of the following materials are described with references to melting ranges. In some examples, a material may exhibit multiple properties of solids, fluids, or gels when at a temperature within the melting range. In some examples, certain formulations of a material may transition from a solid phase to a viscous or liquid phase at a distinct point, or smaller range within the melting range, and other formulations of the same material may transition from a solid phase to a liquid or viscous phase at another district point or another smaller range within the melting range. Generally, it is understood that when a material is at a temperature above the melting range, the material is expected to exhibit viscous or liquid phase characteristics, and when the material is at a temperature below the melting range is expected to exhibit solid phase characteristics.
Polyethylene (PE): PE has a melting range between 115 and 135 degrees C., is chemically resistant, impact resistant, and low cost.
Polyvinyl Alcohol (PVA): PVA can be configured to decompose between 180 and 190 degrees C. and has good film forming properties. Additionally, PVA is water soluble and biodegradable.
PU: PU has a wide glass transition phase, and no distinct melting point, however PU is highly flexible and elastic, and is resistant to abrasion and impacts.
Polystyrene (PS): PS has a melting range between 240 and 270 degrees C. and is relatively low cost. Transparent grades of PS have good clarity.
PMMA: PMMA has a melting range between 160 and 165 degrees C., and has excellent optical clarity, good weather resistance, and high surface hardness.
PLGA: PLGA has a melting range between 50 and 60 degrees C., which is tunable into higher and lower ranges with compositional ratios. PLGA is biodegradable, biocompatible, and has a tunable degradation rate.
Polycaprolactone (PCL): PCL has a melting range between 58 and 63 degrees C., is biodegradable, has a low melting point which provides for ease of processing, good flexibility
Polypropylene (PP): PP has a melting range between 130 and 170 degrees C., is generally lightweight, chemically resistant and fatigue resistant.
Nylon: The melting point of nylons and other amides varies with species, but generally bounded between 190 and 350 degrees C. Nylons and amides have high strength and toughness, good thermal stability, and excellent wear resistance.
Ethylene Vinyl Acetate (EVA): EVA has a melting point between 85 and 90 degrees C., good flexibility and resilience, low-temperature toughness, and has a transparent and glossy appearance.
Cellulose Acetate: Cellulose Acetate decomposes between 230 and 300 degrees C., is biodegradable, has good transparency and gloss, and has excellent film-forming properties.
Poly(ethylene glycol) (PEG): PEG has a melting range between 50 and 60 degrees C., which varies with molecular weight. PEG is water soluble, biocompatible, and has low toxicity.

Some waxes suitable for forming frangible shells which are configured to rupture via the second mode are listed below, as nonlimiting examples.
Paraffin Wax: Paraffin wax has a melting range between 46 and 58 degrees C. and can be tuned to have sharp melting points.
Microcrystalline wax: Microcrystalline wax has a melting range between 60 and 90 degrees C., has high toughness, high flexibility and is thermally stable.
Carnauba Wax: Carnauba wax has a melting range between 82 and 86 degrees C., is naturally occurring and has a high specific hardness.
Montan Wax: Montan wax has a melting range between 72 and 92 degrees C. and has good thermal stability.
Polyethylene (PE) Wax: PE wax has a melting range between 90 and 120 degrees C., high chemical resistance, and good mechanical strength.
Candelilla Wax: candelilla wax has a melting range between 68 and 72 degrees C., has good binding properties, and is naturally occurring.
Fischer-Tropsch Wax: Fischer-Tropsch wax has a tunable melting range up to 110 degrees and is highly crystalline with good thermal stability.

Some inorganics may be used to form frangible shells which are configured to rupture via the second mode, however the melting points of many such substances may exceed 800 degrees C., and some such inorganic materials are not suitable for the disclosed applications.

Microcapsules which are configured to rupture via the second mode, heat exposure, may be formed of one or more of several materials and from one or more of several processes in order to meet user specifications. Several non-limiting examples are given below.

Many of the processes used to form microcapsules configured to rupture via the first mode may also be used to produce microcapsules configured to rupture via the second mode. Some such processes are emulsion polymerization, spray drying, coacervation/phase separation, solvent evaporation, and interfacial polymerization, each of which is described above.

In addition to these processes, freeze drying, or lyophilization, may also be used to form microcapsules configured to rupture via the second mode. Freeze drying involves freezing a solution or suspension of the encapsulating material and core, then sublimating the solvent to leave behind microspheres.

Microcapsules which are configured to rupture via the third mode, internally applied pressure, may utilize any of the above materials according to user specifications. Rupturing a microcapsule with internally applied pressure involves microencapsulating a volatile material and applying heat to the microcapsule, triggering a rapid expansion of the volatile material which ruptures the frangible shell. In some examples, it may be advantageous to form microcapsules configured to rupture via the third mode from the same materials used to from microcapsules configured to rupture via the first mode. Many such examples are heat resistant, such that the frangible shell is not affected by the applied heat used to volatilize the volatile material. Conversely, it may be advantageous to form microcapsules configured to rupture via the third mode from the same materials used to from microcapsules configured to rupture via the second mode. Since the activation action for the third mode is similar to that of the second mode, the applied heat may weaken the frangible shell, such that the volatile material has less resistance when rupturing the microcapsule.

In various examples, microcapsules having frangible shells configured to rupture responsive to a heat exposure may be configured to resist rupturing responsive to a pressure exposure, and microcapsules having frangible shells configured to rupture via pressure exposure may be configured to resist rupturing responsive to heat exposure. In some cases, microcapsules configured to rupture responsive to a heat exposure may include a pressure threshold which will rupture the microcapsules; however, the microcapsules may be configured such that the pressure threshold is outside of a normal or expected operating range of the microcapsules. Similarly, microcapsules configured to rupture responsive to an application of pressure exposure may include a heat threshold which will rupture the microcapsules; however, the microcapsules may be configured such that the heat threshold is outside of a normal or expected operating range of the microcapsules.

Speaking generally of microcapsules which are suitable for deployment in the disclosed applications, the microcapsules may be any size, and in various embodiments, have outer diameter lengths between 20-1000 micrometers (μm), and generally between 50 and 700 μm. The frangible shells may be any size smaller than or equal to the outer diameter of the microcapsule. The microcapsules can have a thickness between 5 to 25 μm. The payload ratio, or the ratio of the total weight of the payload within the microcapsule to the entire weight of the microcapsule including the contents contained within the microcapsule, can range from 20 percent to 90 percent. A variety of microcapsule frangible shell materials may be chosen, depending on the application, the mode of rupture, and the nature of the contents of the microcapsule. In general, the microcapsules should resist the passage, whether by flow, diffusion, or migration, of the contents of the microcapsule prior to rupturing.

### Indicator Materials

According to some embodiments, the microcapsules disclosed herein contain a payload including a liquifiable material and a distinct indicator material. (In other examples, the liquifiable material may itself serve as the indicator material.) When in the solid state, the liquefiable material may substantially prevent movement, migration or diffusion of the indicator material through the liquefiable material. When the liquefiable material is in the liquid state, the indicator material may be able to migrate, move or diffuse through the liquifiable material, and in some examples the indicator material is transportable by the liquefiable material.

Generally, an indicator material produces or facilitates the production of a detectable indication, e.g., an observable effect such as a change in color state or electrical property, in response to a predetermined environmental stimulus, e.g., heating above a threshold temperature. When combined with a liquefiable material, the indicator material is configured to produce, either alone or in combination with other elements, a detectable indication when the liquefiable material liquefies (e.g., in response to a predetermined environmental exposure), or that after having been liquefied, that the liquefiable material has reached a particular destination, travelled a particular distance, or has been liquefied for a predetermined period of time.

Some embodiments of indicator materials discussed here utilize two or more compounds capable of reacting with each other to yield a color change. In some examples, the two or more reactants may be separated within a single microcapsule and prevented from mutual contact by a liquefiable material in a solid state. In some embodiments two or more reactants may be and contained in distinct microcapsules, which substantially prevent the compounds from interacting prior to the rupturing of the microcapsules. Alternatively, a first of the compounds may be contained in the microcapsules, and a second of the compounds may be disposed in an indicator region of the indicator.

Used in combination with the liquifiable material, in some embodiments, are color-reacting materials, such as two reactants kept separate by the microcapsules but allowed to react with each other after rupture or migration. Dyes can also be dissolved in such liquifiable materials to provide an intense color. In some embodiments, the color-reacting materials, or color-forming reactants, produce a distinct color change or change in opacity when brought into contact with each other.

When the reactants come into contact, the appearance change of the indicator may be to go from clear to black, from clear to a dark color, from a light color to a dark color, from a light color to black, etc. In some embodiments, a background is visible through the liquifiable layer(s) prior to the reaction, thereby indicating that the predetermined temperature threshold and required exposure period have not yet been satisfied. The background may include words, numbers, or a pattern, or may simply comprise a color that is easily obscured by the color-forming reaction of the reactants. In some embodiments, a pattern on the background is at least partially obscured by the light color of the liquifiable layer(s), and the pattern becomes more visible after the color-forming reaction. For example, if the pattern is formed with an ink having a color similar to the color of the pre-reacted reactants, a color change produced by the interaction of the color-forming reactants may render the pattern more visible.

In some examples, the liquefiable material may also serve as an indicator material. Some liquefiable materials exhibit visibly detectable changes when undergoing a phase change, such as changes in opacity. Some indicators of the present disclosure may rely on such visibly detectable changes of the liquefiable material as the production of the observable effect, and include components configured to visually emphasize the visibly detectable change when the change occurs.

Some embodiments discussed herein utilize conductive particles which, when employed in tandem with a liquefiable material, may be held separately from one another when the liquefiable material is in the solid phase, and be configured to form an electrical connection between two electrodes when the liquefiable material is in the liquid phase. Thus, by measuring the conductivity between the two electrodes, the state of the liquefiable material can be determined, or rather, an exposure of the liquefiable material to the predetermined environmental exposure may be confirmed. According to some embodiments, the conductive particles may include particles of conductive metals, such as copper, silver, gold, aluminum, zinc, tin, similar metals, and alloys thereof. The conductive particles may also include particles of graphene, graphite, electroconductive carbon black, graphene oxides, and other functionalized graphenes, and particles containing conductive non-metals. The conductive particles may be formed in whole or in part by any electrically conductive substance or material operable to be particlized to a sufficient size to fit within the shell of a microcapsule.

Some embodiments of indicator materials discussed herein utilize colored or bright materials, such as dyes, flash materials, and other colorants. Liquefaction of the liquefiable material may commute the colored material from one region of an indicator to another, indicating liquefaction of the payload. Colors of the indicator and the colored material may be visually contrasting, so as to clearly indicate a change when the liquefiable material liquefies. In some cases flash materials which give off a bright or reflective appearance when illuminated with light of particular wavelengths may be used.

In some examples, liquefaction of the liquefiable material may result in a change in opacity of the liquefiable material, which may reveal or obscure the indicator material. In some examples, the liquifiable material may transport the indicator material from a non-viewable or concealed location to a viewable location when in the liquid state.

### Section II: Rupturable Microcapsules

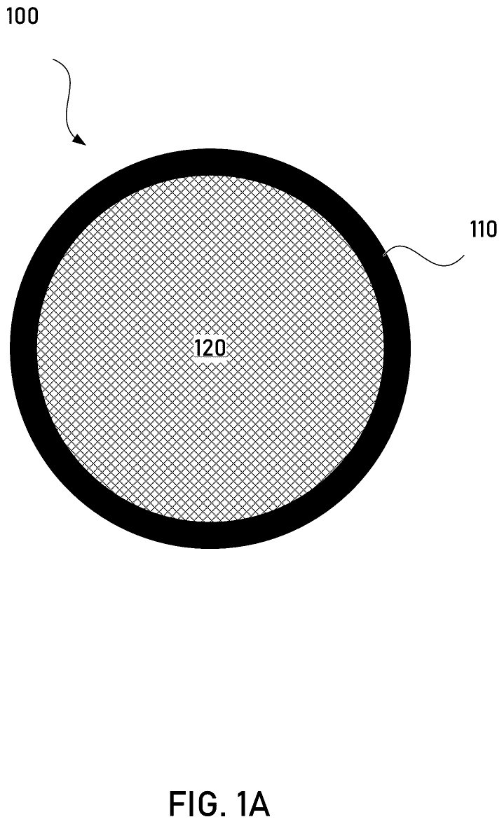

FIG. 1 illustrates a cross-sectional view of a microcapsule 100, as may be used in an activatable indicator, according to embodiments of the present disclosure.

The microcapsule 100 includes a frangible shell 110 which contains a payload 120. In various examples, the frangible shell 110 is configured to contain the payload 120 until an activation action is applied to the microcapsule 100, responsive to which the frangible shell 110 is configured to rupture, or otherwise disengage, and release the payload 120. The frangible shell 110 may include any of the features of frangible shells discussed above in Section I and may be constructed of one or more of the materials discussed above in Section I.

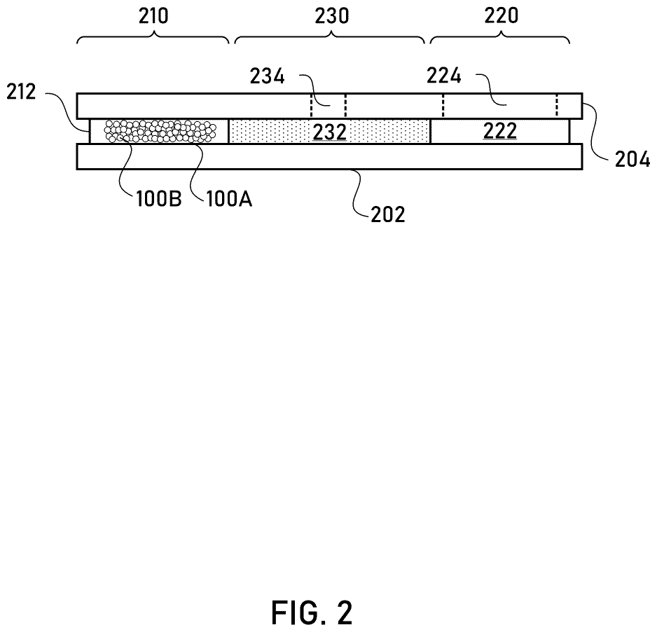

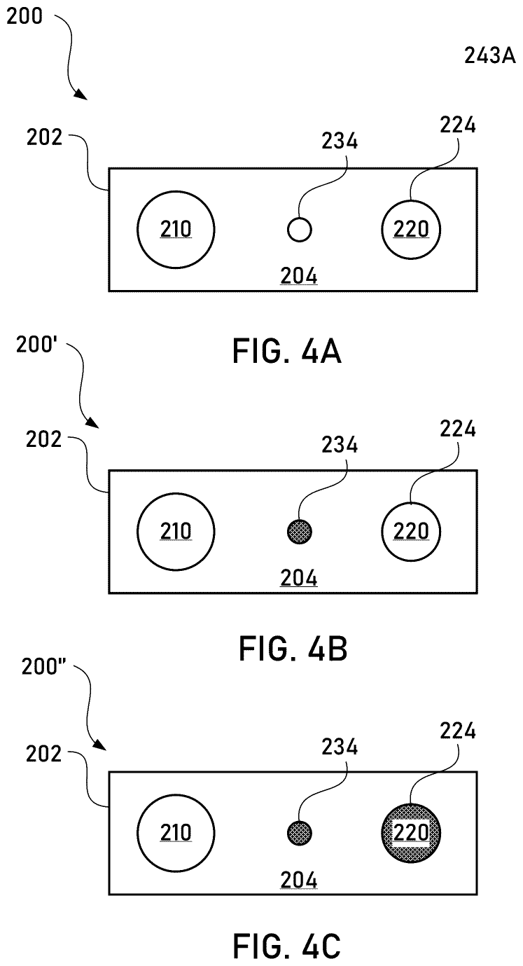

In some examples, the payload 120 includes a liquifiable material combined with an indicator material, which may be configured to produce an effect (e.g., either alone or in tandem with elements of an indicator (see FIGS. 2, 4)) when the liquefiable material transitions from a solid phase to a liquid phase.

With respect to the payload 120, in some examples, the liquifiable material forms a solid matrix when in the solid phase, such that indicator material is embedded within a matrix formed by the liquefiable material. When the liquefiable material liquefies, the liquefiable material may act as a transport material with respect to the indicator material. In such examples, when liquefiable material liquefies, the indicator material is released from the matrix and movement of the indicator material is facilitated through the liquefied liquifiable material. Furthermore, the when the liquefied liquefiable material is acted upon (e.g., by wicking action, capillary action, gravity or other forces) and compelled to motion, the liquefied liquifiable material may transport the indicator material as the liquefiable material moves.

In the present disclosure, the payload 120 includes a sufficient proportion of the liquefiable material that when the liquefiable material liquefies, the payload 120 as a whole, notwithstanding suspended or contained solids (e.g. indicator materials) being contained therein, substantially acts as a liquid. Thus, throughout the disclosure the payload 120 may be said to liquefy. It is understood that reference to the payload 120 liquefying or being liquefied (e.g., and other variations across parts of speech) indicates only that the liquefiable material within the payload 120 is liquefied. Such language does not imply or indicate that the payload 120 does not contain or include non-liquid materials, nor does such language indicate that any material within the payload 120 apart from the liquefiable material is necessarily liquefied.

According to some embodiments, the liquefiable material of the payload 120 may be one of, or a combination of the liquefiable materials listed above in Section I. Furthermore, the indicator material may be one of, or a combination of, the indicator materials listed above in Section I. Moreover, payload 120 materials (e.g., liquefiable materials and indicator materials) may be selected according to other features or design constraints of the indicators with which the microcapsules 100 are to be employed. Some liquefiable materials may exhibit advantageous properties with some wicks, some indicator materials, some temperature ranges, and so forth.

The microcapsule 100 may be any size, but in one such embodiment, has an outer diameter length between 20 to 1000 micrometers (μm). The frangible shell 110 may be any size smaller than or equal to the outer diameter of the microcapsule 100A. The frangible shell 110 can have a thickness of between 5 to 25 μm. The ratio of the total weight of the contents (e.g. thermally expandable microsphere 130, payload 120) within the microcapsule 100 to the entire weight of the microcapsule 100A including the contents contained within the microcapsule 100, can range from 50 percent to 90 percent. A variety of frangible shell 110 materials may be chosen, depending on the application, and the nature of the payload 120 of the microcapsule 100. In general, the frangible shells 110 should resist the passage, whether by flow, diffusion, or migration, of the payload 120 of the microcapsule 100A, prior to activation.

Generally speaking, the microcapsule 100 is configured to be activated responsive to an application of an activation action, or in some examples, two activation actions. When activated, the frangible shell 110 of the microcapsule 100 is disengaged, such that the payload 120 of the microcapsule 100 is exposed to the environment. When the payload 120 is exposed to the environment, an exposure to the predetermined environmental exposure causes the payload 120 to transition to the liquid state. In this manner, when the payload 120 is exposed to the environment, the payload 120 is primed to begin sensing, or is environmentally sensitive.

The microcapsule 100 may be “activated” or ruptured by exposing the microcapsule 100 to an activation action (e.g. activation stress, activation exposure, activation event, etc.) exceeding a predetermined activation threshold. The activation action may cause the microcapsule 100 to fracture, melt, break, dissolve, sublime, become porous, or otherwise disengage, allowing the release of the contents of the microcapsule 100.

In some examples, the frangible shell 110 of the microcapsules 100 is configured to be ruptured by an externally applied pressure. In such embodiments, the activation action is a compressive stress, or a shearing stress, where the predetermined activation threshold is a stress exceeding about 0.1 pounds per square inch (psi), a stress exceeding about 0.5 psi, a stress exceeding about 1 psi, a stress exceeding about 2 psi, a stress exceeding about 5 psi, a stress exceeding about 10 psi, or a stress exceeding about 15 psi.

In some examples, the frangible shell 110 of a microcapsule is configured to be ruptured by an externally applied heat. In such embodiments, the activation action is an application of heat which is applied conductively, convectively, radiatively, or in combination. When the payload 120 of the microcapsule 100 is heat or temperature sensitive, activation may be achieved by applying a high temperature for a very short interval, e.g., a few milliseconds. For example, the mass or heat of fusion of the payload 120 may be much greater than the mass or heat of fusion of the frangible shell 110, allowing a short exposure to high temperature to remove or alter the microcapsule without significantly affecting a thermally sensitive payload contained in the microcapsule.

In some such examples, the predetermined activation threshold may correspond to a temperature exceeding about 35 degrees C., a temperature exceeding about 40 degrees C., a temperature exceeding about 45 degrees C., a temperature exceeding about 50 degrees C., a temperature exceeding about 55 degrees C., a temperature exceeding about 60 degrees C., a temperature exceeding about 65 degrees C., a temperature exceeding about 70 degrees C., a temperature exceeding about 75 degrees C., a temperature exceeding about 80 degrees C., a temperature exceeding about 85 degrees C., a temperature exceeding about 90 degrees C., a temperature exceeding about 95 degrees C., and a temperature exceeding about 100 degrees C. The activation heat ranges given are purely exemplary and the microcapsules can be formed to respond to other temperature ranges.

### Section III: Activatable Environmental Exposure Indicators

### First Embodiment: Time-dependent Indicator With Distinct Activation

FIG. 2 illustrates a first general embodiment of an activatable environmental exposure indicator 200, according to embodiments of the present disclosure. This disclosure describes several variations of the activatable environmental exposure indicator 200, many of which may not appear visually distinct from one another, save for any indicia or interpretive material which may be included when producing an activatable environmental exposure indicator 200. Said differently, many variations of the activatable environmental exposure indicator 200 may have distinctly different features from one another but share a common construction and outward visual appearance. As such, references may be made to an element of FIG. 2 (or of any of the FIGS. 2-4) when discussing a particular variation of an activatable environmental exposure indicator 200, and it is understood that the features discussed with respect to the element may differ from the features of the same element of another variation.

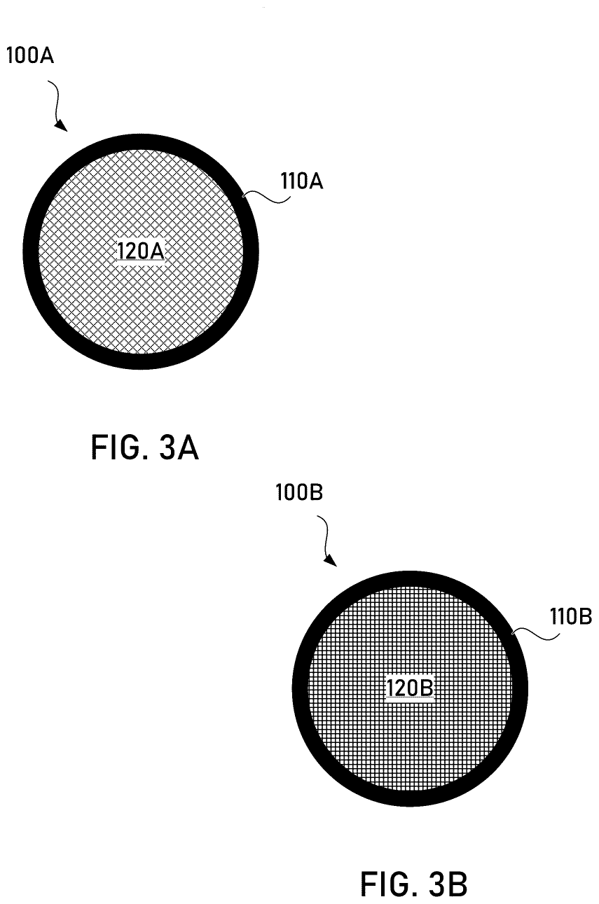

Generally, the activatable environmental exposure indicators 200 of the present disclosure include a substrate 202, which is generally configured to support other components of the activatable environmental exposure indicator 200. An activation region 210 is operatively coupled to the substrate 202. The activation region 210 contains a plurality of first type microcapsules 100A, and a plurality of second type microcapsules 100B, illustrated in greater detail FIGS. 3A-3B. Each first type microcapsule 100A includes a first type frangible shell 110A and a first type payload 120A. Each second type microcapsule 100B includes a second type frangible shell 110B and a second type payload 120B.

The activation region 210 is in fluid communication with an indicator region 220, where fluid communication between the indicator region 220 and the activation region 210 is supported by a migration region 230. The migration region may include a connector component 232, such as a wick, microchannels, or capillary tubes configured to transport liquefied payloads (e.g., first type payload 120A and second type payload 120B).

The first type microcapsules 100A are configured to rupture responsive to a first type activation action being applied to the activation region 210 and release the first type payload 120A. The second type microcapsules 100B are configured to rupture responsive to a second type activation action being applied to the activation region 210 and release the second type payload 120B. According to some embodiments, the first type microcapsules 100A do not rupture in response to the application of the second type activation action to the activation region 210, nor do the second type microcapsules 100B rupture in response to the first type activation action being applied to the activation region 210. Although, it will be appreciated that embodiments could be constructed where one type of microcapsule reacts to both sorts of activation action.

The first payload 120A is configured to liquefy responsive to a first predetermined environmental exposure, and the second type payload 120B is configured to liquefy responsive to a second, distinct predetermined environmental exposure.

In a first use scenario where the second type activation action has not been applied to the activation region 210, after the first type activation action has been applied to the activation region 210, the first payload 120A is released from the first type frangible shells 110A. Responsive to the first predetermined environmental exposure subsequent to the activation, the first payload 120A liquefies and, since the microcapsules have been activated, migrates through the migration region 230 to the indicator region 220 and produces a first observable effect.

In a second use scenario where the first type activation action has not been applied to the activation region 210, after the second type activation action has been applied to the activation region 210 the second payload 120B is released from the second type frangible shells 110B. Responsive to the second predetermined environmental exposure, the second payload 120B liquefies and, having been previously released, migrates through the migration region 230 to the indicator region 220 and produces a second observable effect.

Generally, each activatable environmental exposure indicator 200 has at least two distinct environmental response conditions, and the response condition which is expressed after activation is determined by which activation action or combination of activation actions has been applied to the activation region of the activatable environmental exposure indicator 200.

In various examples, the activation region 210 may include a first reservoir 212 in which the first type microcapsules 100A and the second type microcapsules 100B are disposed. Alternatively, in some examples, the plurality of first type microcapsules 100A may be contained in a first reservoir, and the plurality of second type microcapsules 100B may be contained in a second reservoir, where both the first reservoir and the second reservoir are disposed in close proximity to one another (e.g., overlaying one another, or “side by side”) and jointly housed in the activation region 210. In various examples, the first reservoir 212 may be a reservoir component coupled to the substrate 202, an indentation, recess, protrusion, or embossment of the substrate 202, a blister, or a wick, as non-limiting examples. Generally, the activation region 210 is configured to contain the first type microcapsules 100A and the second type microcapsules 100B within the activation region 210.

The migration region 230 is generally configured such that the first type payload 120A and the second type payload 120B, after being released from the first type frangible shells and the second type frangible shells 110B, respectively, and when liquefied, flow, diffuse, wick, or otherwise migrate through the migration region 230 from the activation region 210 to the indicator region 220. Although in some examples an activatable environmental exposure indicator 200 may include multiple migration regions that respond differently to the different payloads, e.g., one hydrophobic and one not, or two migrations regions having different pore sizes.

In some examples, the first type frangible shells 110A may be configured to rupture responsive to externally applied pressure. In such examples, the first type activation action may be a compressive force applied to the activation region 210, which is configured to transfer a compressive stress to the microcapsules 100A.

Alternatively, the first type frangible shells 110A may be configured to rupture responsive to externally applied heat. In such examples, the first type activation action may be an action which applies heat to the activation region 210. In some examples, the heat may be conductively, convectively or radiatively applied.

In some examples, the second type of frangible shells 110B may respond to the same type of activation action (although at a different threshold) than the first type of frangible shells 110A, or the types of activation actions may be entirely different. The second type frangible shells 110B may be configured to rupture responsive to externally applied pressure. In such examples, the second type activation action may be a compressive force applied to the activation region 210, which is configured to transfer a compressive stress to the microcapsules 100A.

Alternatively, the second type frangible shells 110B may be configured to rupture responsive to externally applied heat. In such examples, the second type activation action may be an action which applies heat to the activation region 210. In some examples, the heat may be conductively, convectively or radiatively applied.

Generally, when the first type activation action is a compressive force, the second type activation action is an application of heat. Similarly, when the first type activation action is an application of heat, the second type activation action is a compressive force. In this manner, first type microcapsules 100A are not ruptured (e.g., remain intact) by the application of the second type activation action and the second type microcapsules 100B are not ruptured (e.g., remain intact) by the first type activation action. However, as described herein, it will also be appreciated that the activation type could be the same, but with different thresholds, e.g., different activation pressures and/or temperatures.

In some examples, the first predetermined environmental exposure may be a temperature excursion above a predetermined temperature threshold, temperature excursion below a predetermined temperature threshold, an exposure to a particular chemical, an oxygen exposure, an ammonia exposure, an exposure to a particular chemical above a threshold concentration, an exposure to a particular chemical above the threshold concentration, an exposure to at least a predetermined amount of radiation of a particular type, a predetermined electromagnetic exposure, a humidity exposure, and an exposure to a humidity level above a predetermined threshold.

In some examples, the second predetermined environmental exposure may be a temperature excursion above a predetermined temperature threshold, temperature excursion below a predetermined temperature threshold, an exposure to a particular chemical, an oxygen exposure, an ammonia exposure, an exposure to a particular chemical above a threshold concentration, an exposure to a particular chemical above the threshold concentration, an exposure to at least a predetermined amount of radiation of a particular type, a predetermined electromagnetic exposure, a humidity exposure, and an exposure to a humidity level above a predetermined threshold.

The first type payload 120A is configured to produce an observable effect upon reaching the indicator region 220. In some examples, the indicator material of the first payload 120A is a dye, ink, or other colorant, and the indicator region 220 appears to change from an initial color state to a second color state. In some examples, indicator material is a two-component dye or ink, which produces a change in color state upon mixing two reactants together. In some examples, the first reactant is contained in the first type payload 120A and the second reactant is contained in the indicator region 220 such that when the liquefied first type payload 120A reaches the indicator region 220 the first and second reactants are mixed, producing the color change in the indicator region 220. In some examples, the indicator material in the first type payload 120A may be a flash material, which is configured to give off a bright appearance when illuminated with light of a predetermined wavelength. In some examples, the indicator material in the first type payload 120A may be a conductive material, such that the observable effect is a change in an electrical property of the indicator region 220.

The second type payload 120B is configured to produce an observable effect upon reaching the indicator region 220. In some examples, the indicator material of the first payload 120B is a dye, ink, or other colorant, and the indicator region 220 appears to change from an initial color apparent state to a second apparent color state. In some examples, indicator material is a two-component dye or ink, which produces a change in color state upon mixing two reactants together. In some examples, the first reactant is contained in the second type payload 120B and the second reactant is contained in the indicator region 220 such that when the liquefied second type payload 120B reaches the indicator region 220 the first and second reactants are mixed, producing the color change in the indicator region 220. In some examples, the indicator material in the second type payload 120B may be a flash material, which is configured to give off a bright appearance when illuminated with light of a predetermined wavelength. In some examples, the indicator material in the second type payload 120B may be a conductive material, such that the observable effect is a change in an electrical property of the indicator region 220. In such examples, the electrical property may be one or more of conductivity, resistivity, impedance, capacitance, and inductance, as measured by a circuit connected to the indicator region.

In some examples, the activatable environmental exposure indicator 200 includes a cover layer 204 which may include one or more indicator viewing windows 224, which may provide for a user to view the indicator region 220 (e.g., or at least a portion thereof) through the cover layer 204, and may further include one or more migration viewing windows 234 which may provide for a user to view the migration region 230 (e.g., or at least a portion thereof) through the cover layer 204.

FIGS. 4A-4C illustrate views of the activatable environmental exposure indicator 200 in various states according to embodiments of the present disclosure. The illustrated embodiment of the activatable environmental exposure indicator 200 includes one migration viewing window 234 and one indicator viewing window 224. FIG. 4A illustrates the activatable environmental exposure indicator 200 at a point in time prior to either the first type activation action being applied to the activation region 210 or the second type activation action being applied to the activation region 210.

FIG. 4B illustrates the activatable environmental exposure indicator 200′ after activation (e.g., one or both of the first type activation action and the second type activation action has been applied to the activation region 210) and after the activatable environmental exposure indicator 200 has been exposed to the predetermined environmental exposure corresponding to the type of microcapsules 100 ruptured by the applied activation action(s), for an amount of time which is less than the corresponding predetermined period of time for the corresponding observable effect to be produced in the indicator region 220. In FIG. 4B, the payload 120 (e.g., first type payload 120A, second type payload 120B) has migrated through a portion of the migration region 230, such that the payload 120 is viewable in the migration region 230 through the migration viewing window 234.

FIG. 4C illustrates the activatable environmental exposure indicator 200″ after activation (e.g., one or both of the first type activation action and the second type activation action has been applied to the activation region 210) and after the activatable environmental exposure indicator 200 has been exposed to the predetermined environmental exposure corresponding to the type of microcapsules 100 ruptured by the applied activation action(s), for the corresponding predetermined period of time for the corresponding observable effect to be produced in the indicator region 220. In FIG. 4C, the observable effect has been produced in the indicator region 220 and is viewable through the indicator viewing window 224.

### First Variation: Distinct Time Response to a Single Exposure

In a first variation, the activatable environmental exposure indicator 200 is a time temperature indicator, where, once activated, the activatable environmental exposure indicator is configured to produce an observable effect in the indicator region 220 responsive to exposure to a temperature above a predetermined exposure threshold for at least a predetermined amount of time, where the predetermined amount of time is selectable by a user and depends on the method of activation.

In the first variation, the first type microcapsules 100A include frangible shells which are configured to rupture via externally applied pressure, and the first type activation action is an application of a compressive force to the activation region 210. The second type microcapsules are configured to rupture via exposure to heat and the second type activation action is an application of heat to the activation region 210.

The first type payload 120A is configured to liquefy responsive to exposure to temperatures above a predetermined temperature threshold, and has a first viscosity when liquefied (e.g., when at temperatures above the predetermined exposure threshold). When released from the first type frangible shells 110A and liquefied, the first type payload 120A and migrates though the migration region 230 at a first predetermined rate. As the migration region 230 is of a predetermined or fixed size, the first payload 120A reaches the indicator region 220 after a first predetermined amount of time for which the first type payload 120A is liquefied. Thus, when the first activation action is applied to the activation region 210, the time response of the activatable environmental exposure indicator 200 is a first time response.

The second type payload 120B is configured to liquefy responsive to exposure to temperatures above the predetermined temperature threshold, and has a second viscosity when liquefied (e.g., when at temperatures above the predetermined exposure threshold). When released from the second type frangible shells 110B and liquefied, the second type payload 120B and migrates though the migration region 230 at a second predetermined rate. As the migration region 230 is of a predetermined or fixed size, the second payload 120B reaches the indicator region 220 after a first predetermined amount of time for which the second type payload 120B is liquefied. Thus, when the second type activation action is applied to the activation region 210, the time response of the activatable environmental exposure indicator 200 is a second time response.

Both the first type payload 120A and the second type payload 120B are configured to liquefy when exposed to temperatures above the predetermined temperature threshold, but to have distinctly different viscosities when liquefied. The greater the viscosity of the liquefied payload, the slower the predetermined rate of migration through the migration region, and the greater amount of time required for the liquefied payload to reach the indicator region 220 and produce the observable effect. In addition, or alternatively, the predetermined temperature threshold at which the first type of payload 120A liquifies can be the same or different than the predetermined temperature threshold at which the second type of payload 120B liquifies.

In this manner, a user may select whether the activatable environmental exposure indicator is configured to indicate the first time response and the second time response to the same or different predetermined temperature threshold by applying the corresponding activation action.

In some examples, when the first type activation action and the second type activation action are both applied to the activation region 210 (e.g., simultaneously, or consecutively and prior to environmental exposures), both the plurality of first type microcapsules and the plurality of second type microcapsules 100B are ruptured, respectively releasing the first type payload 120A and the second type payload 120B. Responsive to exposure to a temperature (e.g., or temperatures) above the predetermined temperature threshold, both the first type payload 120A and the second type payload 120B liquefy and combine, forming a combined payload, which migrates through the migration region 230 at a third predetermined rate and reaches the indicator region 220 after a third predetermined amount of time for which the combined payload is liquefied. Thus, when the first type activation action and the second type activation action are jointly applied to the activation region 210, the time response of the activatable environmental exposure indicator 200 is a third time response. In one example, the third response time can be greater than the first time response and less than the second time response. In addition, or alternatively, when the first payload 120A and second payload 120B are combined, the predetermined temperature threshold at which the combined payload liquifies can be the same or different than the predetermined temperature threshold at which the first payload 120A and/or the second payload 120B liquify. For embodiments in which the predetermined temperature thresholds at which the first payload 120A, the second payload 120B, and the combined payload can each be different. As an example, the predetermined temperature threshold at which the second payload 120B liquifies can be greater than the predetermined temperature threshold at which the first payload 120A liquifies, and the predetermined temperature threshold at which the combined payload liquifies can be greater than the predetermined temperature threshold at which the first payload 120A liquifies and less than the predetermined temperature threshold at which the second payload 120A liquifies.

In such examples, a user may select whether the activatable environmental exposure indicator is configured to indicate the first time response, the second time response, or the third time response to the same or different predetermined temperature threshold by applying the corresponding activation action, or both activation actions.

In some examples, the indicator material of the first type payload 120A may be a different indicator material than that of the second type payload 120B. In such examples, the first observable effect is distinct from the second observable effect and may serve to indicate which time response is being indicated. In such examples, the combined payload includes a combination of the indicator materials of the first type payload 120A and the second type payload 120B, which may produce a third observable effect distinct from one or both of the first observable effect and the second observable effect.

In other examples, the indicator material may be shared by both the first type payload 120A and the second type payload 120B, and the first observable effect and the second observable effect are the same observable effect. In some such examples, the third observable effect is the same observable effect as the first observable effect and the second observable effect.

Generally, both the first type payload 120A and the second type payload 120B are configured to liquefy and remain liquefied while exposed to temperatures above the predetermined temperature threshold and solidify and remain solidified while exposed to temperatures below the predetermined temperature threshold. Both the first type payload 120A, the second type payload 120B and the combined payload are configured to halt migration through the migration region 230 when exposed to temperatures below the predetermined temperature threshold, and resume migration through the migration region 230 when again exposed to temperatures above the predetermined temperature threshold. In this manner, the time dependent response of the indicator corresponds to the amount of time for which the activatable environmental exposure indicator 200 is exposed to temperatures above the predetermined temperature threshold.

In various examples, the second time response may be between 1.1 and 5 times longer than the first time response, or vice versa. In other examples, the second time response may be more than 5 times greater than the first time response.

In various examples, the first payload 120 and the second payload 130 may be configured to liquefy responsive to exposure to temperatures between 0 degrees C. and 150 degrees C.

As a non-limiting example, a first variation activatable environmental exposure indicator 200 may be an indicator which is configured to indicate exposure to temperatures above 40 degrees C. By applying a pressure activation action to the activation region 210, the indicator region 220 may change from a white appearance to a red appearance once the activatable environmental exposure indicator 200 has been exposed to temperatures in excess of 40 degrees C. for 12 hours or more. Alternatively, by applying a heat activation action to the activation region 210, the indicator region may change from a white appearance to a blue appearance once the activatable environmental exposure indicator 200 has been exposed to temperatures in excess of 40 degrees C. for 24 hours or more. Alternatively, by simultaneously (or in rapid succession) applying both a pressure activation action and a heat activation action to the activation region 210, the indicator region 220 will change from a white appearance to a purple appearance once the activatable environmental exposure indicator 200 has been exposed to temperatures in excess of 40 degrees C. for 18 hours or more. In the foregoing example, the indication temperature, time responses, activation actions, and changes of appearance (e.g., observable effects) are purely exemplary, any of the referenced variables may be tuned, altered or reconfigured without departing from the scope of the present disclosure.

In an example use case scenario, a dairy processing facility ships three products, skim milk, whole milk, and heavy cream. Depending on a customer's order, the dairy processing facility may ship packages containing just skim milk, just whole milk, just heavy cream, or packages containing a combination of the dairy products. Skim milk, having a lower fat content than heavy cream or whole milk is more prone to spoilage due to thermal exposures than heavy cream or whole milk. In this example, to avoid spoilage, or potential spoilage conditions, the skim milk must not exceed 4 degrees C. for more than 3 hours, the whole milk must not exceed 4 degrees C. for more than 5 hours, whereas the heavy cream is safe at 4 degrees C. for 3 and 5 hours but must not exceed 4 degrees C. for more than 7 hours.

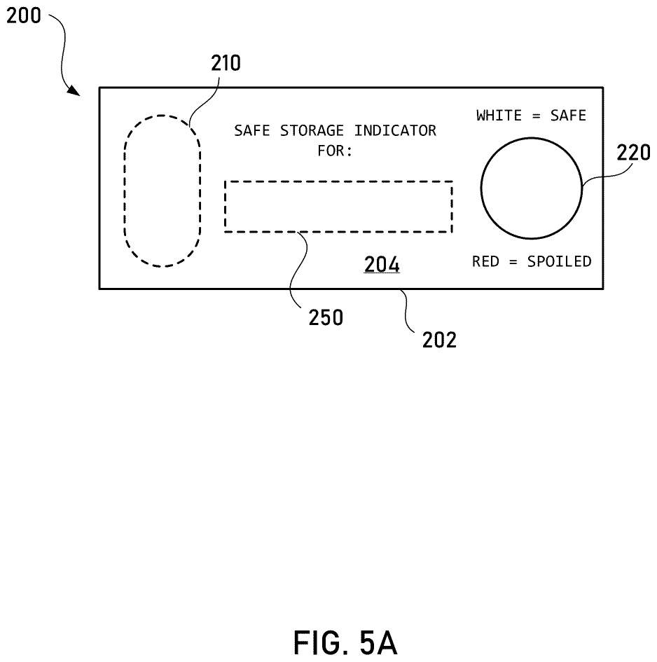

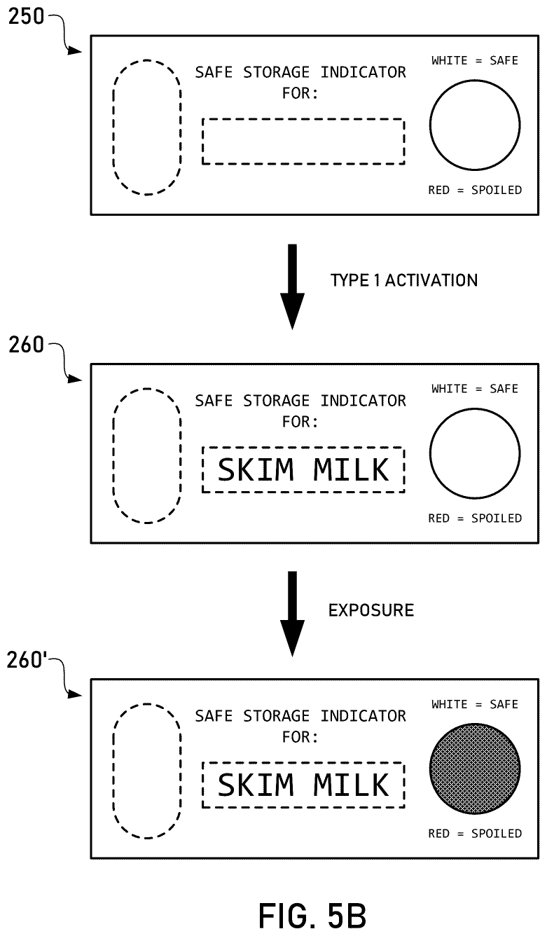

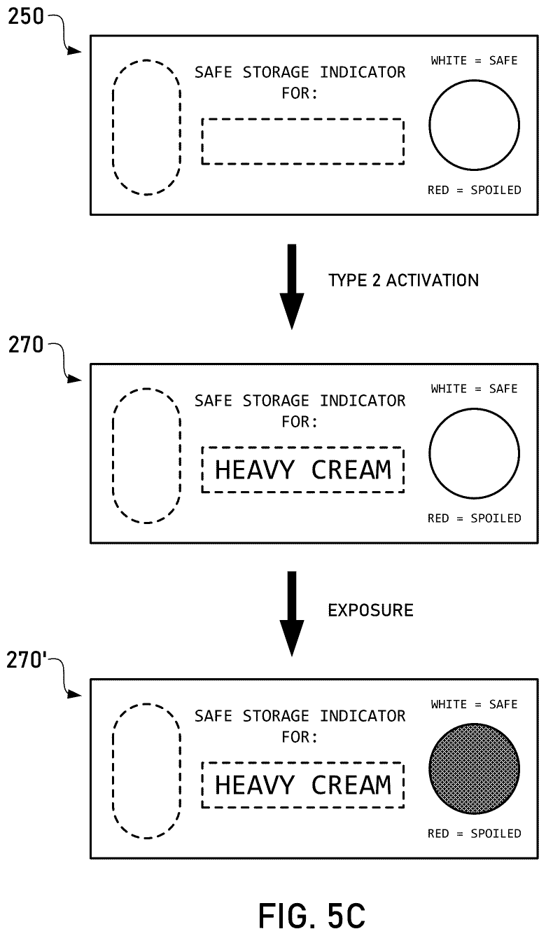

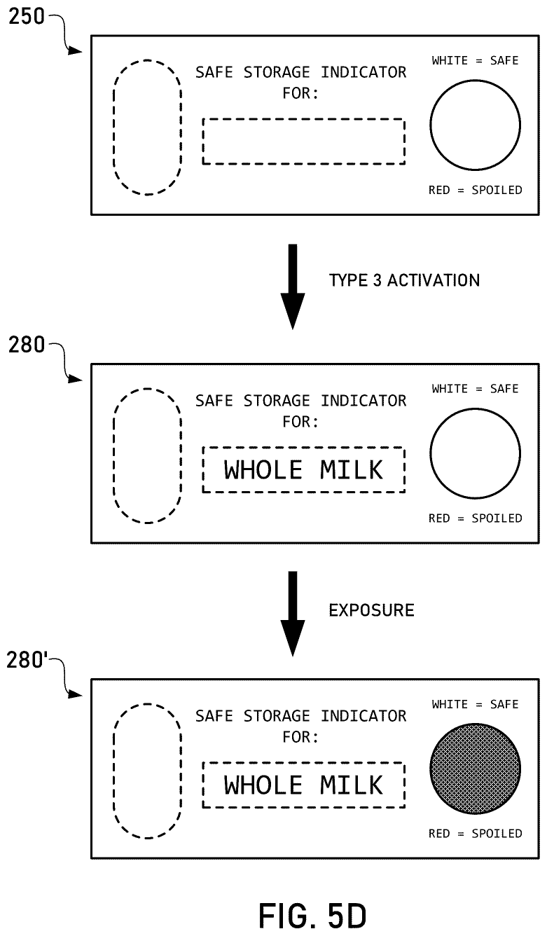

An indicator manufacturer provides the dairy plant with a supply of activatable environmental exposure indicators 250 (illustrated in FIG. 5A) which are activatable and printable by a thermal printer. The activatable environmental exposure indicators 250 include all the features of the activatable environmental exposure indicators 200, and further include a data region 252 in which is printable by the thermal printer. In some examples the data region 252 may include the entirety of cover layer 204. Both the data region 252 and the activation region 210 are marked in FIGS. 5A-5C by dotted lines, however in practice these features may not be marked or otherwise visually indicated.

The thermal printer is configured to selectively apply a type 1 activation, a type 2 activation or a type 3 activation to each activatable environmental exposure indicator 250, and print, in the data region, corresponding indicia.

FIG. 5B illustrates a type 1 activation and exposure process. The type 1 activation is a pressure type activation action, which is applied to the activation region 210 via a print roller (e.g., platen) forming a nip with a printhead which crushes the plurality of first type microcapsules 100A, rupturing the first type frangible shells 110A and releasing the first type payload 120A. The first type payload 120A is configured to liquefy at 4 degrees C., and has a “low” viscosity when liquefied, and requires 3 hours while liquefied to migrate to the indicator region 220 (after the pressure type activation is applied). Upon reaching the indicator region 220, the liquefied first payload 120A changes the indicator region 220 from a white color state to a red color state by commuting a red dye thereto. When the thermal printer applies the type 1 activation action, the thermal printer prints “SKIM MILK” in the data region to indicate that the indicator is primed to indicate a spoilage exposure corresponding to skim milk (3 hours above 4 degrees C.). Thus, the activatable environmental exposure indicator 250 is primed to sense an exposure to temperatures above 4 degrees C. for 3 hours or more and includes a printed indicia labelling the activatable environmental exposure indicator 250 as a skim milk indicator 260.

When a dairy worker packs a package containing skim milk, the worker operates the thermal printer to apply the type 1 activation to one of the activatable environmental exposure indicators 250, yielding a skim milk indicator 260. When the customer receives the package, if the indicator region 220 of the skim milk indicator 260′ appears red, then the customer is informed that the skim milk has been exposed to spoilage conditions.

FIG. 5C illustrates a type 2 activation and exposure process. The type 2 activation is a heat type activation, which is applied to the activation region 210 by engaging heating elements of the thermal printhead and melting the second type frangible shells 110B of the plurality of second type microcapsules 100B, releasing the second type payload 120B. The second type payload 120B is configured to liquefy at 4 degrees C. and has a “high” viscosity when liquefied and requires 7 hours while liquefied to migrate to the indicator region 220 (after the heat type activation is applied). Upon reaching the indicator region 220, the liquefied second payload changes the indicator region 220 from a white color state to a red color state by commuting a red dye thereto. When the thermal printer applies the type 2 activation action, the thermal printer prints “HEAVY CREAM” in the data region to indicate that the indicator is primed to indicate a spoilage exposure corresponding to heavy cream (7 hours above 4 degrees C.). Thus, the activatable environmental exposure indicator 250 is primed to sense an exposure to temperatures above 4 degrees C. for 7 hours or more and includes a printed indicia labelling the activatable environmental exposure indicator 250 as a heavy cream indicator 270.

When a dairy worker packs a package containing heavy cream alone, the worker operates the thermal printer to apply a type 2 activation one of the activatable environmental exposure indicators 200, yielding a heavy cream indicator 270. The worker packs the heavy cream indicator 270 with the dairy products and ships the package. When the customer receives the package, if the indicator region 220 of the heavy cream indicator 270′ appears red, then the customer is informed that the heavy cream has been exposed to spoilage conditions.

FIG. 5D illustrates a type 3 activation and exposure process. The type 3 activation is a combination of the pressure type activation and the heat type activation, both of which are applied to the activation region 210 by the thermal printer. The first type frangible shells 110A and the second type frangible shells 110B are ruptured, releasing both the first type payload 120A and the second type payload 120B. After being released, and when first exposed to a temperature above 4 degrees C., the first type payload 120A and the second type payload 120B form a combined payload which has a “medium” viscosity when liquefied and requires 5 hours while liquefied to migrate to the indicator region 220. Upon reaching the indicator region 220, the liquefied combined payload changes the indicator region 220 from a white color state to a red color state by commuting a red dye thereto. When the thermal printer applies the type 3 activation action, the thermal printer prints “WHOLE MILK” in the data region to indicate that the indicator is primed to indicate a spoilage exposure corresponding to whole milk (5 hours above 4 degrees C.). Thus, the activatable environmental exposure indicator 250 is primed to sense an exposure to temperatures above 4 degrees C. for 5 hours or more and includes a printed indicia labelling the activatable environmental exposure indicator 250 as a whole milk indicator 280.

When a dairy worker packs a package containing whole milk, and not skim milk, the worker operates the thermal printer to apply type 3 activation to one of the activatable environmental exposure indicators 250, yielding a whole milk indicator 280. The worker packs the whole milk indicator 280 with the dairy products and ships the package. When the customer receives the package, if the indicator region 220 of the whole milk indicator 280′ appears red, then the customer is informed that the whole milk has been exposed to spoilage conditions.

### Second Variation: Response to Distinct Exposures

In a second variation, the activatable environmental exposure indicator 200 is a time temperature indicator configured to produce an observable effect in the indicator region 220 responsive to exposure to a temperature above a predetermined exposure threshold for at least a predetermined amount of time, where the predetermined exposure threshold is selectable by a user and depends on the method of activation.

The first type payload 120A is configured to liquefy responsive to exposure to temperatures above a first predetermined temperature threshold. When released from the first type frangible shells 110A and liquefied, the first type payload 120A and migrates though the migration region 230 to the indicator region 220 and produces the first observable effect.

The second type payload 120B is configured to liquefy responsive to exposure to temperatures above a second predetermined temperature threshold. When released from the second type frangible shells 110B and liquefied, the second type payload 120B and migrates though the migration region 230 to the indicator region 220 and produces a second observable effect.

In various examples, the first type payload 120A and the second type payload 120B may have similar viscosities when liquefied. In such examples, the time response of the activatable environmental exposure indicator 200 may be identical for each activation type.

In various examples, the first payload 120A and the second type payload 120B may have different viscosities when liquefied. In such examples, the time response of the activatable environmental exposure indicator 200 differs between activation types.

In some examples, the indicator material of the first type payload 120A may be a different indicator material than that of the second type payload 120B. In such examples, the first observable effect is distinct from the second observable effect and may serve to indicate which predetermined temperature threshold is being indicated.

In other examples, the indicator material may be shared by both the first type payload 120A and the second type payload 120B, and the first observable effect and the second observable effect are the same observable effect.

Generally, both the first type payload 120A and the second type payload 120B are configured to liquefy and remain liquefied while exposed to temperatures above the respective predetermined temperature threshold and solidify and remain solidified while exposed to temperatures below the respective predetermined temperature threshold. Both the first type payload 120A, and the second type payload 120B are configured to halt migration through the migration region 230 when exposed to temperatures below the respective predetermined temperature threshold, and resume migration through the migration region 230 when again exposed to temperatures above the respective predetermined temperature threshold. In this manner, the time dependent response of the indicator corresponds to the amount of time for which the activatable environmental exposure indicator 200 is exposed to temperatures above the respective predetermined temperature threshold.

As a non-limiting example, the second variation of the activatable environmental exposure indicator 200 may be an indicator which is configured to indicate exposure to temperatures above one of two temperature thresholds lasting more than 3 hours. After pressure is applied, e.g., via a user or device (e.g., a printer or tamper), to the activation region 210, and when the activatable environmental exposure indicator 200 has been exposed to temperatures in excess of 65 degrees C. for 3 hours, the indicator region 220 changes from an opaque appearance to a transparent appearance, revealing printed indicia. Alternatively, after heat is applied, e.g., via a heating device such as a heat gun, a printer, or other heating device, to the activation region 210, e.g., for 3 seconds, and when the activatable environmental exposure indicator 200 has been exposed to temperatures in excess of 85 degrees C. for 3 hours, the indicator region 220 changes from the opaque appearance to the transparent appearance, revealing the printed indicia. In the foregoing example, the indication temperature, activation actions, and changes of appearance (e.g., observable effects) are purely exemplary, any of the referenced variables may be tuned, altered or reconfigured without departing from the scope of the present disclosure.

As a non-limiting example, an activatable environmental exposure indicator 200 has three distinct types of microcapsules and is activatable by a thermal printer. The first distinct type of microcapsule is configured to be ruptured by a thermal printer at a 100 degree C. print setting, and releases a first payload which is configured to liquefy at 40 degrees C., and has a viscosity such that the payload is configured to produce an observable effect after 1 hour of exposure above 40 degrees C. The second distinct type of microcapsule is configured to be ruptured by a thermal printer at a 110 degree C. print setting, which ruptures both the first distinct microcapsules and the second distinct microcapsules. The second distinct microcapsules release a payload which is configured to mix with the first payload and increase the viscosity of the first payload when liquefied such that the first payload and the second payload are configured to produce an observable effect after 12 hours of exposure above 40 degrees C. The third distinct type of microcapsule is configured to be ruptured by a thermal printer at a 120 degree C. print setting, which ruptures both the first distinct microcapsules, the second distinct microcapsules and the third distinct microcapsules. The third distinct microcapsules release a payload which is configured to increase the viscosity of the first payload and the second payload when liquefied such that the first payload, the second payload, and the third payload are configured to produce an observable effect after 24 hours of exposure above 40 degrees C. While the predetermined temperature threshold remains constant for the three different responses in the foregoing example, embodiments can include different predetermined temperatures and different response times. For example, the first payload can be configured to produce an observable effect after a first specified amount of time (e.g., 4 hours) above a first specified temperature (e.g., 0 degrees C.), the combination of the second pay load can be configured to produce an observable effect after a second specified amount of time (e.g., 12 hours) above a second specified temperature (e.g., 37 degrees C.), and the combination of the first payload, the second payload, and the third payload can be configured to produce an observable effect after a third specified amount of time (e.g., 8 hours) above a third specified temperature (e.g., 7 degrees C.).

### Second Embodiment: Excursion Indicator With Distinct Activation

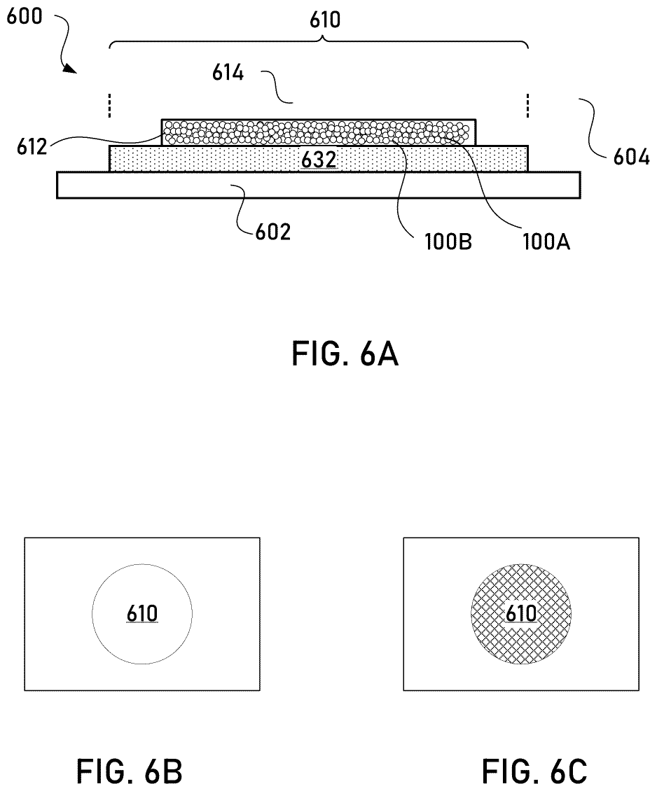

FIG. 6A illustrates a second general embodiment of an activatable environmental exposure indicator 600, according to embodiments of the present disclosure. Generally, the activatable environmental exposure indicators 600 of the present disclosure include a substrate 602, which is generally configured to support other components of the activatable environmental exposure indicator 600. An indicator region 610 is operatively coupled to the substrate 602. The indicator region 610 contains the plurality of first type microcapsules 100A, and the plurality of second type microcapsules 100B, illustrated in greater detail FIGS. 3A-3B. Each first type microcapsule 100A includes the first type frangible shell 110A and the first type payload 120A. Each second type microcapsule 100B includes the second type frangible shell 110B and the second type payload 120B. The indicator region 610 further includes a wick 632 which is disposed adjacent to the microcapsules 100A and 100B. Note that in the second general embodiment of the activatable environmental exposure indicator 600, the indicator region 610 includes similar features to that of both the activation region 210 and indicator region 220 of the first general embodiment of the activatable environmental exposure indicator 200. In the context of the second general embodiment of the activatable environmental exposure indicator 600, the indicator region 610 may be considered to be both an activation region and an indicator region.

The first type microcapsules 100A are configured to rupture responsive to a first type activation action being applied to the indicator region 610 and release the first type payload 120A. The second type microcapsules 100B are configured to rupture responsive to a second type activation action being applied to the indicator region 610 and release the second type payload 120B. According to some embodiments, the first type microcapsules 100A do not rupture in response to the application of the second type activation action to the indicator region 610, nor do the second type microcapsules 100B rupture in response to the first type activation action being applied to the indicator region 610.

The first payload 120A is configured to liquefy responsive to a first predetermined environmental exposure, and the second type payload 120B is configured to liquefy responsive to a second predetermined environmental exposure.

In a first use scenario where the second type activation action has not been applied to the indicator region 610, after the first type activation action has been applied to the indicator region 610, the first payload 120A is released from the first type frangible shells 110A. Responsive to the first predetermined environmental exposure, the first payload 120A liquefies and saturates the wick 632 which produces a first observable effect in the indicator region 610.

In a second use scenario where the first type activation action has not been applied to the indicator region 610, after the second type activation action has been applied to the indicator region 610 and, the second payload 120B is released from the second type frangible shells 110B. Responsive to the second predetermined environmental exposure, the second payload 120B liquefies and saturates the wick 632 which produces a second observable effect in the indicator region 610.

Generally, each activatable environmental exposure indicator 600 has at least two response conditions, and the response condition which is expressed after activation is determined by which activation action is applied to the activation region of the activatable environmental exposure indicator 600.

In various examples, the first observable effect and the second observable effect may be the same effect or different effects.

Although illustrated as including a wick 632, in various examples, the indicator region 610 may include a reservoir, or another medium which is configured to become saturated (e.g., partially or entirely), filled (e.g., partially or entirely), or otherwise populated by the liquefied first payload 120A or second type payload 120B.

In various examples, the microcapsules 100A and 100B may be combined together in the indicator region 610. In various examples, the microcapsules 100A and 100B may be sandwiched between the wick 632 and the substrate 602, or between the wick 632 and the cover layer 604.

In some examples, the cover layer 604 includes a viewing window 614 which is configured such that the indicator region 610 is viewable to a user viewing the activatable environmental exposure indicator 600. The viewing window 614 may be configured such that, in examples where the observable change is visually observable, the observable change may be viewed.

In some examples, the first type frangible shells 110A may be configured to rupture responsive to externally applied pressure. In such examples, the first type activation action may be a compressive force applied to the indicator region 610, which is configured to transfer a compressive stress to the microcapsules 100A.

In some examples, the first type frangible shells 110A may be configured to rupture responsive to externally applied heat. In such examples, the first type activation action may be an action which applies heat to the indicator region 610. In some examples, the heat may be conductively, convectively or radiatively applied.

In some examples, the second type frangible shells 110B may be configured to rupture responsive to externally applied pressure. In such examples, the second type activation action may be a compressive force applied to the indicator region 610, which is configured to transfer a compressive stress to the microcapsules 100A.

In some examples, the second type frangible shells 110B may be configured to rupture responsive to externally applied heat. In such examples, the second type activation action may be an action which applies heat to the indicator region 610. In some examples, the heat may be conductively, convectively or radiatively applied.

Generally, when the first type activation action is a compressive force, the second type activation action is an application of heat. Similarly, when the first type activation action is an application of heat, the second type activation action is a compressive force. In this manner, first type microcapsules 100A are not ruptured by the application of the second type activation action and the second type microcapsules 100B are not ruptured by the first type activation action.

In some examples, the first predetermined environmental exposure may be a temperature excursion above a predetermined temperature threshold, temperature excursion below a predetermined temperature threshold, an exposure to a particular chemical, an oxygen exposure, an ammonia exposure, an exposure to a particular chemical above a threshold concentration, an exposure to a particular chemical above the threshold concentration, an exposure to at least a predetermined amount of radiation of a particular type, a predetermined electromagnetic exposure, a humidity exposure, and an exposure to a humidity level above a predetermined threshold.

In some examples, the second predetermined environmental exposure may be a temperature excursion above a predetermined temperature threshold, temperature excursion below a predetermined temperature threshold, an exposure to a particular chemical, an oxygen exposure, an ammonia exposure, an exposure to a particular chemical above a threshold concentration, an exposure to a particular chemical above the threshold concentration, an exposure to at least a predetermined amount of radiation of a particular type, a predetermined electromagnetic exposure, a humidity exposure, and an exposure to a humidity level above a predetermined threshold.

The first type payload 120A is configured to produce an observable effect upon reaching the indicator region 610. In some examples, the indicator material of the first payload 120A is a dye, ink, or other colorant, and the indicator region 610 appears to change from an initial color state to a second color state. In some examples, indicator material is a two-component dye or ink, which produces a change in color state upon mixing two reactants together. In some examples, the first reactant is contained in the first type payload 120A and the second reactant is contained in the indicator region 610 such that when the liquefied first type payload 120A reaches the indicator region 610 the first and second reactants are mixed, producing the color change in the indicator region 610. In some examples, the indicator material in the first type payload 120A may be a flash material, which is configured to give off a bright appearance when illuminated with light of a predetermined wavelength. In some examples, the indicator material in the first type payload 120A may be a conductive material, such that the observable effect is a change in an electrical property of the indicator region 610.

The second type payload 120B is configured to produce an observable effect upon reaching the indicator region 610. In some examples, the indicator material of the first payload 120B is a dye, ink, or other colorant, and the indicator region 610 appears to change from an initial color state to a second color state. In some examples, indicator material is a two-component dye or ink, which produces a change in color state upon mixing two reactants together. In some examples, the first reactant is contained in the second type payload 120B and the second reactant is contained in the indicator region 610 such that when the liquefied second type payload 120B reaches the indicator region 610 the first and second reactants are mixed, producing the color change in the indicator region 610. In some examples, the indicator material in the second type payload 120B may be a flash material, which is configured to give off a bright appearance when illuminated with light of a predetermined wavelength. In some examples, the indicator material in the second type payload 120B may be a conductive material, such that the observable effect is a change in an electrical property of the indicator region 610.

As a non-limiting example, an activatable environmental exposure indicator 600 may be an indicator which is configured to indicate exposure to temperatures above one of two temperature thresholds. After nip pressure is applied to the indicator region 610 by a thermal printer during a thermal printing process, and when the activatable environmental exposure indicator 600 has been subsequently exposed to temperatures in excess of 75 degrees C., the indicator region 610 changes from a white appearance (See FIG. 6B) to a dark appearance (See FIG. 6C). Alternatively, after the indicator region 610 is exposed to heat from heating elements of a thermal printhead during a thermal printing process, and when the activatable environmental exposure indicator 600 has been subsequently exposed to temperatures in excess of 100 degrees C., the indicator region 610 changes from the white appearance (See FIG. 6B) to the dark appearance (See FIG. 6C). In some examples, the activatable exposure indicator 60 may indicate exposure a third temperature threshold when the indicator 600 is exposed to both the first type of activation and the second type of activation. In one example, the third temperature threshold can be greater than the first temperature threshold (e.g., 75 degrees C.) and less than the second temperature threshold (e.g., 100 degrees C.). In the foregoing example, the temperature thresholds, activation actions, and changes of appearance (e.g., observable effects) are purely exemplary, any of the referenced variables may be tuned, altered or reconfigured without departing from the scope of the present disclosure.

In a non-limiting example, an activatable environmental exposure indicator 600 includes three distinct types of microcapsules. The first distinct type of microcapsule includes a payload configured to liquefy at a first temperature threshold, e.g., 35 degrees C. The second distinct type of microcapsule includes a second payload which is configured to liquefy at a second temperature threshold, e.g., 37 degrees C. The second distinct type of microcapsule includes a third payload configured to liquefy at a third temperature threshold, e.g., 39 degrees C. The first distinct type of microcapsules is configured to rupture responsive to a compressive force type activation action, the second distinct type of microcapsules are configured to rupture responsive to a first heat type activation action, and the third distinct type of microcapsules are configured to rupture to a second heat type activation, the second heat type activation action having a lower threshold than the first heat type activation. The first type heat activation activates both the second and third distinct types of microcapsules. Since an excursion above 39 degrees C. is inherently an excursion above 37 degrees C., indication of the 37-degree excursion by the second payload is unaffected by the release of the third payload. Conversely, the second heat type activation is insufficient to rupture the second distinct type of microcapsule, as releasing the second payload would interfere with the indication of a 39-degree excursion by the third payload.

In a non-limiting example, and activatable environmental exposure indicator 600 may be activatable by a thermal printer and have three types of microcapsules. The first type of microcapsule is configured to be ruptured by the thermal printer at a 100 degree C. print setting, and indicate exposures above 60 degrees C., the second type of microcapsule is configured to be ruptured by the thermal printer at a 110 degree C. print setting and indicate exposures above 55 degrees C., and the third type of microcapsules is configured to be ruptured by a thermal printer at a 120 degree C. print setting and indicate exposures above 50 degrees C. Similar to the previous example, the 120 degree C. print setting may activate the first, second and third microcapsules, but the payload of the third microcapsules, having the lowest exposure threshold, liquefy and produce the observable effect regardless of the release or liquefication of the first and second payloads. The same principle applies for the first and second microcapsules rupturing at the 110 degree C. print setting.

### Method of Forming Activatable Environmental Exposure Indicators

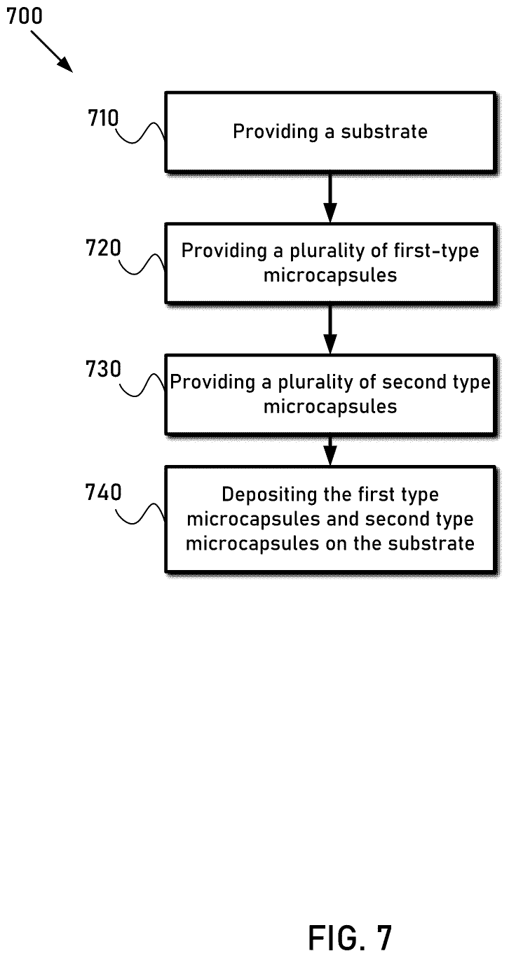

FIG. 7 illustrates a flowchart of a method 700 for forming activatable environmental exposure indicators, according to embodiments of the present disclosure. The method 700 may be used to produce one or more activatable environmental exposure indicators 200 of FIGS. 2-3B, or one or more activatable environmental exposure indicators 500 of FIGS. 5A-5C.

Block 710 of the method 700 describes a step in which a substrate is provided. The substrate (e.g., substrate 202, 502) may be a media element and may include a defined indicator region, activation region, migration region, indicia and other features. In some examples, an indicator region, activation region or indicia may be coupled to or imparted on the substrate or during the step described by block 710. The substrate may be an individual substrate or may be defined in a web of connected substrates.

Block 720 of the method 700 describes a step in which a plurality of first type microcapsules is provided. Each first type microcapsule (e.g., first type microcapsule 100A) includes a first type frangible shell and a first type payload. The first type frangible shells are configured to rupture responsive to a first activation action (e.g., a first type of activation) being applied to the microcapsules and release the first type payload. The first type payload is configured to liquefy responsive to a first predetermined environmental exposure. Prior to the first type activation action being applied to the microcapsules, the first type frangible shells are configured to contain the first type payload when the microcapsule is exposed to the first predetermined environmental exposure.

Block 730 of the method 700 describes a step in which a plurality of second type microcapsules is provided. Each second type microcapsule (e.g., second type microcapsule 100B) includes a second type frangible shell and a second type payload. The second type frangible shells are configured to rupture responsive to a second activation action (e.g., a second type of activation that is different than the first type of activation or the first type of activation using a different activation threshold) being applied to the microcapsules and release the second type payload. The second type payload is configured to liquefy responsive to a first predetermined environmental exposure. Prior to the second type activation action being applied to the microcapsules, the second type frangible shells are configured to contain the second type payload when the microcapsule is exposed to the second predetermined environmental exposure.

Block 740 of the method 700 describes a step in which the plurality of first type microcapsules and the plurality of second type microcapsules are deposited on the substrate. In some examples, the plurality of first type microcapsules and the plurality of second type microcapsules (collectively “microcapsules”) are deposited together onto the substrate. In some examples the microcapsules are deposited in a dry or powder form. In some examples, the microcapsules may be deposited while suspended in a transfer medium, such as a liquid or gel, in a “wet” form. In some examples, the first type microcapsules are deposited separately from the second type microcapsules. In some examples the first type microcapsules may be deposited over the second type microcapsules or vice versa. In some examples the first type microcapsules may be deposited adjacent to the second type microcapsules in close proximity. In some examples the microcapsules are deposited into a reservoir, which is coupled to or formed in the substrate. In some examples the microcapsules are deposited onto a wick which is coupled to the substrate.

In some examples, other components and features may be coupled to the substrate as may be included in an activatable environmental exposure indicator, such as embodiments of the activatable environmental exposure indicator 200 and embodiments of the activatable environmental exposure indicator 600.

In some examples, after the step of block 740, a cover layer may be applied to the substrate, such that the microcapsules are contained between the substrate and the cover layer.

After the steps of block 740, the method 700 may be concluded.

### Method of Use for Activatable Environmental Exposure Indicators

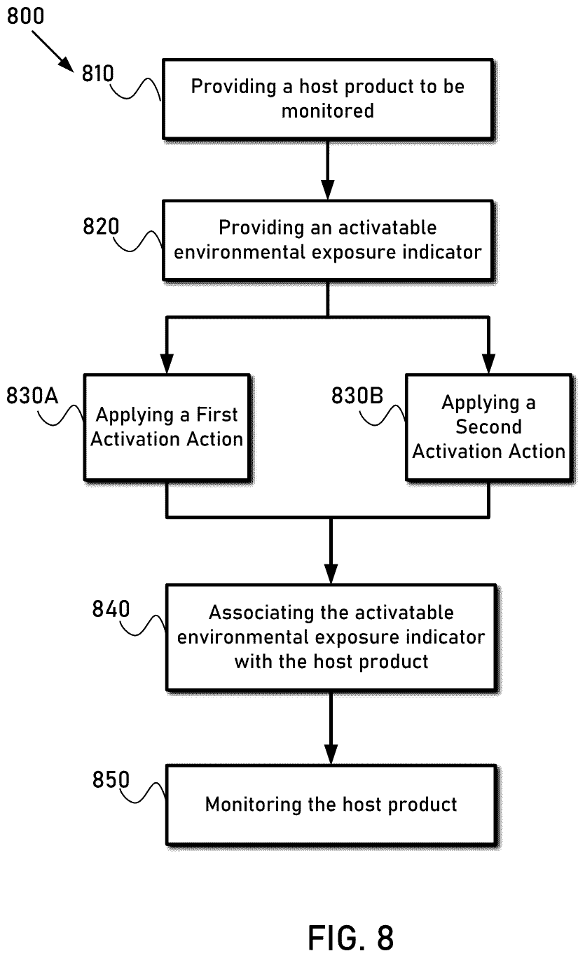

FIG. 8 illustrates a flowchart of an example method of use 800 for the activatable environmental exposure indicators (e.g., activatable environmental exposure indicator 200, activatable environmental exposure indicator 250, activatable environmental exposure indicator 60) disclosed herein, according to embodiments of the present disclosure.

Block 810 describes a step of the method of use 800 in which a host product to be monitored is provided. The host product may have an environmental sensitivity, where exposure to a particular environmental condition may render the host product inert, spoiled, or otherwise unusable.

Block 820 of the method of use 800 describes providing an activatable environmental exposure indicator, according to embodiments of the present disclosure. The activatable environmental exposure indicator may be an activatable environmental exposure indicator 200, an activatable environmental exposure indicator 250, and or activatable environmental exposure indicator 600, or any of the example activatable environmental exposure indicators discussed above in Section III. The activatable environmental exposure indicator may be initially provided in an unactivated state, which ensures that the activatable environmental exposure indicator is not compromised or expended prior to use. The activatable environmental exposure indicator may be provided as a user may desire to monitor the environmental conditions to which the host product is exposed so as to determine whether the host product has been exposed to the environmental condition to which the host product is sensitive.

Generally, the activatable environmental exposure indicator is configured to monitor for an exposure to one of at least two conditions. The user may routinely work with more than one type of host product, and each host product may have a different environmental sensitivity. To fulfill this need, without supplying two separate types of indicators, a single activatable environmental exposure indicator may be provided to monitor for a first environmental condition when a first type activation action is applied, and a monitor for a second environmental condition when a second type activation action is applied.

Block 830A of the method of use 800 describes applying a first activation action to the activatable environmental exposure indicator, according to embodiments of the present disclosure. The user or a device (e.g., a printer) may apply the first activation action (e.g., a first type of activation) when the user or device determines that the first type environmental condition corresponds to the environmental sensitivity of the host product. The user or the device may apply the first activation action to an activation region of the activatable environmental exposure indicator, as is described above in Section III.

Block 830B of the method of use describes applying a second activation action to the activatable environmental exposure indicator, alternatively to applying the first type activation action, according to embodiments of the present disclosure. The user or a device (e.g., printer) may apply the second activation action (e.g., a second type of activation that is different than the first type of activation or the first type of activation using a different activation threshold) when the user or device determines that the second type environmental condition corresponds to the environmental sensitivity of the host product. The user or the device may apply the second activation action to the activation region of the activatable environmental exposure indicator, as is described above in Section III.

Block 840 of the method 400 describes associating the activatable environmental exposure indicator with the host product, according to embodiments of the present disclosure. Once the particular environmental condition for which to monitor has been determined and the corresponding activation action applied, the activatable environmental exposure indicator may be associated with the host product. In some examples, the activatable environmental exposure indicator may be co-packaged with the host product, and in other examples the activatable environmental exposure indicator may be affixed or coupled to the host product. In some examples, the activatable environmental exposure indicator includes an adhesive label, which may be used to secure the activatable environmental exposure indicator to the host product. For embodiments in which the activatable exposure indicator includes an adhesive label, the label may be affixed to the host product by a user or a device (e.g., a label applicator).

Block 850 of the method of use 800 describes monitoring the host product, according to embodiments of the present disclosure. In many expected use cases, the activatable environmental exposure indicator may be used with the host product when the host product must be left unobserved or otherwise unattended for a period of time, although the activatable environmental exposure indicator may be employed in constant monitoring processes as well. Generally, a user or imaging or machine vision system may observe the activatable environmental exposure indicator when examining the host product, and if an observable effect, or product thereof, is present in the indicator region, then the user or imaging or machine vision system may determine that the host product has been exposed to the environmental condition for which the activatable environmental exposure indicator is configured to monitor. If no observable effect is present or observed then a user or imaging or machine vision system may infer that no exposure to the environmental condition for which the activatable environmental exposure indicator is configured to monitor has occurred.

After the monitoring period has concluded, the method of use 800 may be concluded.

In the foregoing specification, specific embodiments have been described. However, one of ordinary skill in the art appreciates that various modifications and changes can be made without departing from the scope of the technology as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any manner. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed technology is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain manner is configured in at least that manner but may also be configured in manners that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An activatable environmental exposure indicator, comprising:
a substrate;
an indicator region defined on, or operatively coupled to the substrate;
an activation region in fluid communication with the indicator region;
a plurality of first type microcapsules disposed in the activation region, each first type microcapsule of the plurality of first type microcapsules including a first type payload microencapsulated in a first type frangible shell,
wherein the first type frangible shells are configured to rupture and release the first type payload responsive to a first type activation action being applied to the activation region, and contain the first type payload prior to first type activation action being applied to the activation region,
wherein the first type payload includes a first type liquefiable material configured to liquefy responsive to a first type of predetermined environmental exposure, the first type payload having a first viscosity when the first type liquefiable material is liquefied,
wherein after being released from the first type frangible shells and when the first type liquefiable material is liquefied, the first type payload is configured to flow from the activation region into the indicator region and produce a first observable effect in the indicator region after a first predetermined period of time; and
a plurality of second type microcapsules disposed in the activation region, each second type microcapsule of the plurality of second type microcapsules including a second type payload microencapsulated in a second type frangible shell;
wherein the second type frangible shells are configured to rupture and release the second type payload responsive to a second type activation action being applied to the activation region, and remain intact and contain the second type payload when the first type activation action is applied to the activation region, prior to the second type activation action being applied to the activation region,
wherein the second type payload includes a second type liquefiable material configured to liquefy responsive to the predetermined environmental exposure, the second type payload having a second viscosity when the second type liquefiable material is liquefied,
wherein after being released from the second type frangible shells and responsive to the predetermined environmental exposure, the second type payload is configured to flow from the activation region into the indicator region and produce a second observable effect in the indicator region after a second predetermined period of time, the second predetermined period of time being greater than the first predetermined period of time;
wherein the first type frangible shells are configured to remain intact and contain the first type payload when the second type activation action is applied.

2. The activatable environmental exposure indicator of claim 1, wherein after the first type payload is released from the first type frangible shells and liquefied, the first type liquefiable material is configured to solidify when not exposed to the predetermined environmental exposure, such that flow of the first type payload to the indicator region is halted when the activatable environmental exposure indicator is no longer exposed to the predetermined environmental exposure and flow of the first type payload to the indicator region resumes when the predetermined environmental exposure resumes, such that the first predetermined period of time is an amount of time for which the first type payload is exposed to the predetermined environmental exposure.

3. The activatable environmental exposure indicator of claim 1, wherein the first observable effect and the second observable effect are a same observable effect.

4. The activatable environmental exposure indicator of claim 3, wherein after the second type payload is released from the second type frangible shells and liquefied, the second type liquefiable material is configured to solidify when not exposed to the predetermined environmental exposure, such that flow of the second type payload to the indicator region is halted when the activatable environmental exposure indicator is no longer exposed to the predetermined environmental exposure and flow of the second type payload to the indicator region resumes when the predetermined environmental exposure resumes, such that the second predetermined period of time is an amount of time for which the second type payload is exposed to the predetermined environmental exposure.

5. The activatable environmental exposure indicator of claim 3, after the first type activation action and the second type activation action are applied to the activation region, and responsive to the predetermined environmental exposure, the first type payload and the second type payload liquefy and combine, forming a combined material having a third viscosity, the combined material configured flow from the activation region into the indicator region and produce the observable effect after a third predetermined period of time.

6. The activatable environmental exposure indicator of claim 5, wherein when the combined material is formed and liquefied, the combined material is configured to solidify when not exposed to the predetermined environmental exposure, such that flow of the combined material to the indicator region is halted when the activatable environmental exposure indicator is no longer exposed to predetermined environmental exposure and flow of the combined material to the indicator region resumes when the predetermined environmental exposure resumes, such that the third predetermined period of time is an amount of time for which the combined material is exposed to the predetermined environmental exposure, the third time being distinct from the first predetermined period of time or the second predetermined period of time.

7. The activatable environmental exposure indicator of claim 1, wherein one of the first type activation action and the second type activation action is a heat exposure above a predetermined activation threshold.

8. The activatable environmental exposure indicator of claim 1, wherein one of the first type activation action and the second type activation action is compression or shear stress exceeding a predetermined stress threshold.

9. The activatable environmental exposure indicator of claim 1, wherein the second predetermined period of time is between 1.1 times and 5 times longer than the first predetermined period of time.

10. The activatable environmental exposure indicator of claim 1, wherein the first type payload contains a first indicator material configured to produce the first observable effect in the indicator region.

11. The activatable environmental exposure indicator of claim 1, wherein the second type payload contains a second indicator material configured to produce the second observable effect in the indicator region.

12. The activatable environmental exposure indicator of claim 9, wherein the first type payload contains a first indicator material and the observable effect in the indicator region is a first observable effect, and the second type payload contains a second indicator material and the observable effect in the indicator region is a second observable effect, distinct from the first observable effect.

13. The activatable environmental exposure indicator of claim 1, wherein one or both of the first type frangible shells and the second type frangible shells are formed from a material selected form a group consisting of polyurethane, polylactic acid, ethyl cellulose, poly(lactic-co-glycolic acid), poly(methyl methacrylate), nylon, silicone elastomers, natural rubber, polymelamine formaldehyde, polyurea formaldehyde, styrene-butadiene rubber, polybutadiene rubber, nitrile butadiene rubber, silica, calcium carbonate, alumina, borosilicate glass, zinc oxide and combinations thereof.

14. The activatable environmental exposure indicator of claim 1, wherein one or both of the first type frangible shells and the second type frangible shells are formed from a material selected form a group consisting of polyethylene, polyvinyl alcohol, polyurethane, polystyrene, poly(methyl methacrylate), poly(lactic-co-glycolic acid), polycaprolactone, polypropylene, nylon, ethylene vinyl acetate, cellulose acetate, poly(ethylene glycol), a polyamide/urea hybrid, paraffin wax, microcrystalline wax, carnauba wax, Montan wax, polyethylene wax, candelilla wax, fischer-tropsch wax, and combinations thereof.

15. The activatable environmental exposure indicator of claim 1, wherein one or both of the first type frangible shells and the second type frangible shells have shell thicknesses in a range of 2 to 700 micrometers (μm).

16. The activatable environmental exposure indicator of claim 1, wherein one or both of the of first type microcapsules and second type microcapsules includes a volatile material microencapsulated along with the respective payload, the volatile material configured to expand responsive to the respective activation action, rupturing the respective frangible shells.

17. The activatable environmental exposure indicator of claim 1 wherein the predetermined environmental exposure is selected from a group consisting of: a temperature excursion above a predetermined temperature threshold, temperature excursion below a predetermined temperature threshold, an exposure to a particular chemical, an oxygen exposure, an ammonia exposure, an exposure to a particular chemical above a threshold concentration, an exposure to at least a predetermined amount of radiation of a particular type, a predetermined electromagnetic exposure, a humidity exposure, and an exposure to a humidity level above a predetermined threshold.

18. The activatable environmental exposure indicator of claim 1, wherein one or both of the first observable effect and the second observable effect is a change in an apparent color state of at least a portion of the indicator region resulting from the one or both of the first type payload and the second type payload reaching the portion of the indicator region.

19. The activatable environmental exposure indicator of claim 18, wherein one or both of the first type payload and the second type payload contains an indicator material configured to change the apparent color state of the indicator region, the indicator material selected from a group consisting of: a dye, a colorant, an ink, a first reactant configured to react with a second reactant disposed in the indicator region to produce a color state change, a reflective material, a flash material configured to give a bright appearance when illuminated with light of a predetermined wavelength, and combinations thereof.

20. The activatable environmental exposure indicator of claim 1, wherein one or both of the first observable effect and the second observable effect is a change in an electrical property of the indicator region as detected by a circuit connected to the indicator region, wherein the electrical property is selected from a group consisting of conductivity, resistivity, impedance, capacitance, and inductance and a respective of the first type payload and the second type payload includes a plurality of conductive particles configured to change the electrical property of the indicator region, the plurality of conductive particles selected from a group consisting of particles containing copper, particles containing silver, particles containing graphite, particles containing graphene, particles containing graphene oxide, particles containing other functionalized graphenes, particles containing conductive metals, particles containing conductive non-metal materials, electroconductive carbon black, and combinations thereof.

21. The activatable environmental exposure indicator of claim 1, wherein the first type payload includes a first reactant, and the indicator region includes a second reactant, and when the first type payload reaches the indicator region, the first reactant has a reaction with the second reactant to form a product, wherein one of the reaction and the product produces the first observable effect in the indicator region.

22. The activatable environmental exposure indicator of claim 1, wherein the second type payload includes a first reactant, and the indicator region includes a second reactant, and when the second type payload reaches the indicator region, the first reactant has a reaction with the second reactant to form a product, wherein one of the reaction and the product produces the second observable effect in the indicator region.

23. The activatable environmental exposure indicator of claim 1, wherein the indicator region and the activation region are in fluid communication via a connector component is selected from a group consisting of a wick, a plurality of capillary tubes, a plurality of microchannels, and combinations thereof.

24. An activatable environmental exposure indicator, comprising:
a substrate;
an indicator region defined on, or operatively coupled to the substrate;
an activation region in fluid communication with the indicator region;
a plurality of first type microcapsules disposed in the activation region, each first type microcapsule of the plurality of first type microcapsules including a first type payload microencapsulated in a first type frangible shell;
wherein the first type frangible shells are configured to rupture and release the first type payload responsive to a first type activation action being applied to the activation region, and contain the first type payload prior to the first type activation action being applied to the activation region,
wherein the first type payload includes a first type liquefiable material configured to liquefy responsive to a first predetermined environmental exposure,
wherein after being released from the first type frangible shells and when the first type liquefiable material is liquefied, the first type payload is configured to migrate from the activation region into the indicator region and produce a first observable effect in the indicator region; and
a plurality of second type microcapsules disposed in the activation region, each second type microcapsule of the plurality of second type microcapsules including a second type payload microencapsulated in a second type frangible shell;
wherein the second type frangible shells are configured to rupture and release the second type payload responsive to a second type activation action being applied to the activation region, and remain intact and contain the second type payload when the first type activation action is applied to the activation region and prior to the second type activation action being applied to the activation region,
wherein the second type payload includes a second type liquefiable material configured to liquefy responsive to a second predetermined environmental exposure,
wherein after being released from the second type frangible shells and responsive to the second predetermined environmental exposure, the second type payload is configured to migrate from the activation region into the indicator region and produce a second observable effect in the indicator region;
wherein the first type frangible shells are configured to remain intact and contain the first type payload when the second activation action is applied.

25. The activatable environmental exposure indicator of claim 24, wherein the first predetermined environmental exposure is an exposure to a temperature above a first temperature threshold, and the second predetermined environmental exposure is an exposure to a temperature above a second temperature threshold, the second temperature threshold exceeding the first temperature threshold.

26. The activatable environmental exposure indicator of claim 24, wherein after the first type payload is released from the first type frangible shells, and when the first type liquefiable material is liquefied, the first type payload has a first viscosity and produces the observable effect in the indicator region after a first predetermined period of time; and after the second type payload is released from the second type frangible shells and when the second type liquefiable material is liquefied, the second type payload has a second viscosity and produces the observable effect in the indicator region after a second predetermined period of time.

27. The activatable environmental exposure indicator of claim 24, wherein the first predetermined environmental exposure is an exposure to a temperature above a first temperature threshold, after the first type payload is released from the first type frangible shells, and when the first type liquefiable material is liquefied, the first type payload has a first viscosity and produces the observable effect in the indicator region after a first predetermined period of time; and the second predetermined environmental exposure is an exposure to a temperature above a second temperature threshold, the second temperature threshold exceeding the first temperature threshold and after the second type payload is released from the second type frangible shells and when the second type liquefiable material is liquefied, the second type payload has a second viscosity and produces the observable effect in the indicator region after a second predetermined period of time, the second predetermined period of time being less than the first predetermined period of time.

28. The activatable environmental exposure indicator of claim 24, wherein the first type payload contains a first indicator material and the observable effect in the indicator region is a first observable effect, and the second type payload contains a second indicator material and the observable effect in the indicator region is a second observable effect, distinct from the first observable effect.

29. A method of forming an activatable environmental exposure indicator, the method comprising:
providing a substrate comprising an activation region in fluid communication with an indicator region;
providing a plurality of first type microcapsules, each first type microcapsule including a first type payload material microencapsulated in a first type frangible shell,
wherein the first type payload material comprises a first type liquefiable material configured to liquefy responsive to a predetermined environmental exposure and have a first viscosity when liquefied;
providing a plurality of second type microcapsules, each second type microcapsule including a second type payload microencapsulated in a second type frangible shell,
wherein the second type payload comprises a second type liquefiable material, configured to liquefy responsive to the predetermined environmental exposure and have a second viscosity when liquefied; and
depositing the plurality of first type microcapsules and the plurality of second type microcapsules in the activation region;
wherein the first type frangible shells are configured to rupture and release the first type payload when a first activation action is applied to the activation region;
wherein the second type frangible shells are configured to rupture and release the second type payload when a second activation action is applied to the activation region; and
wherein the first type frangible shells are configured to remain intact and contain the first type payload when the first type liquefiable material is liquefied, when the first type liquefiable material is solidified, and when the second activation action is applied to the activation region, prior to the first activation action being applied to the activation region;
wherein the second type frangible shells are configured to remain intact and contain the second type payload when the second type liquefiable material is liquefied, when the second type liquefiable material is solidified and when the first activation action is applied to the activation region, prior to the second activation action being applied to the activation region.

30. The method of claim 29, wherein after being released from the first type frangible shells and when the first type liquefiable material is liquefied, the first type payload is configured to flow from the activation region into the indicator region and produce an observable effect in the indicator region after a first predetermined period of time; and after being released from the second type frangible shells and responsive to the predetermined environmental exposure, the second type payload is configured to flow from the activation region into the indicator region and produce the observable effect in the indicator region after a second predetermined period of time.
